(19) United States
(12) Patent Application Publication
(10) Pub. No.: US 2010/0310728 A1
(43) Pub. Date: Dec. 9, 2010

(54) ENCAPSULATED OMEGA-3 FATTY ACIDS FOR BAKED GOODS PRODUCTION

(75) Inventors: Bernhard H. van LENGERICH, Plymouth, MN (US); Goeran WALTHER, Plymouth, MN (US)

Correspondence Address: GENERAL MILLS, INC., P.O. BOX 1113, MINNEAPOLIS, MN, 55440, US

(73) Assignee: GENERAL MILLS, INC., MINNEAPOLIS, MN (US)

(21) Appl. No.: 12/794,089

(22) Filed: Jun. 4, 2010

Related U.S. Application Data
(60) Provisional application No. 61/184,681, filed on Jun. 5, 2009.

(51) Int. Cl. A21D 13/06; A21D 13/00; A21D 10/00; C11B 5/00

(52) U.S. Cl. 426/94; 426/549; 426/128; 426/541

(57) ABSTRACT

Encapsulated polyunsaturated fatty acids which can be incorporated into a baked good dough or batter without smearing or dissolution of the encapsulated product contains film-coated oil droplets encapsulated by a matrix material, a liquid plasticizer which plasticizes the matrix material, and an acidic antioxidant dispersed throughout the plasticized matrix material which helps to prevent oxidation of the polyunsaturated fatty acids; and the production of a fishy taint or malodors and mal-flavors. The matrix material includes a starch component which helps to avoid a rubbery consistency and texture and promotes extrudability, and a protein component, which hardens the encapsulated product and prevents substantial smearing and dissolution during dough or batter mixing and baking. The matrix material protein content is from about 25% to about 77.5% by weight of the matrix material. The protein content of the encapsulated product is from about 15% to about 65% by weight, of the encapsulated product.

### CROSS REFERENCE TO RELATED APPLICATIONS

This application claims priority of U.S. Provisional Patent Application Ser. No. 61/184,681, filed Jun. 5, 2009 for “Encapsulated Omega-3 Fatty Acids For Baked Goods Production” in the names of Bernhard H. van Lengerich and Goeran Walther, the disclosure of which is herein incorporated by reference in its entirety.

### FIELD OF THE INVENTION

The present invention generally relates to baked goods, such as bread, containing encapsulated readily oxidizable polyunsaturated fatty acids (PUFAs), and more particularly, to baked goods containing encapsulated omega-3 fatty acids, the encapsulated fatty acids, and doughs and batters containing them for use in making baked goods, and methods for making the baked goods where the free fatty acids such as omega-3 fatty acids are stabilized against oxidation.

### BACKGROUND OF THE INVENTION

Prophylactic and therapeutic benefits of PUFAs such as omega-3 fatty acids and their role as anti-inflammatory agents are well-proven. Recent clinical studies have further suggested that consumption of sufficient amounts of these polyunsaturated fatty acids may be adequate for intervention treatment for animals and humans suffering from rheumatoid arthritis. Dietary sources of PUFAs such as omega-3 fatty acids can be found mainly in foods from marine sources such as algae and fish. In most populations, however, the nutritional benefits of PUFA compounds cannot be realized due to the low consumption of fish and edible algae. With the U.S. Food and Drug Administration's current allowance for health claims relating to intake of omega-3 fatty acids for protection from heart disease, there is an increased interest in fortifying food products with these components. One main problem that hinders the incorporation of PUFA oils into processed foods is the oil's high degree of unsaturation, its susceptibility to oxidation and the subsequent deteriorative effects on flavor and aroma of the oil.

The sensitivity of PUFA oils to oxidation generally restricts its unprotected use to low temperature, short life food such as yogurt or cooled beverages, such as orange juice and milk. For long shelf life dry food such as cereal or granola bars, omega-3 oils generally need to be encapsulated for oxidation protection. Commercially available PUFA encapsulated products are mostly spray dried powders which generally exhibit unacceptable sensory attributes. Also, products which may exhibit bulk stability often fail in application studies after two or three weeks in accelerated shelf life testing at 55° C. which is approximately the equivalent of six or nine month stability, respectively at room temperature.

The encapsulation of PUFA oils in small granulated pellets may be employed to increase oxidative and sensorial stability to four weeks or more in accelerated storage at 55° C. which is approximately the equivalent of one year or more at room temperature, which is a desirable extended shelf life for ready-to-eat cereals and granola bars. However, encapsulated PUFA pellets still need to be handled very carefully and not treated with excess heat, moisture, or high shear forces during food processing. Also, a dry pellet may not be compatible in texture with certain types of foods.

Also, in encapsulating a component in a matrix, the matrix material is generally heated to a sufficiently high temperature to provide a plasticized mass which facilitates embedding or coating of the component. Upon cooling, the matrix material hardens or becomes solidified and protects the encapsulant from undesirable or premature reaction. Grinding of a solidified or glassy product to obtain a desired particle size for incorporation in foods or beverages generally results in the formation of irregularly-shaped pieces and rough surfaces. Irregularly shaped pieces and creviced surfaces tend to result in non-uniform encapsulant release, increased diffusion of liquid encapsulants, and increased penetration of oxygen and water which may deleteriously affect sensitive encapsulants, such as readily oxidizable components. Incorporation of a water soluble antioxidant, such as an acidic antioxidant into a dry matrix material with a fluid reaction medium such as water or glycerin for the antioxidant to improve antioxidant mobilization may result in a water activity which is not shelf stable, may adversely affect a desirable texture, may adversely affect the release properties of the matrix, or may promote dissolution of pellets of the encapsulated PUFA during dough or batter mixing.

Small, soft pellets containing encapsulated PUFA's and an acidic anti-oxidant with a mobilizing fluid such as glycerin, provide long term anti-oxidative activity and good adhesion for topical application to a cereal base such as flakes, puffs or clusters. However, the pellet attributes of being small and soft have been found to produce counter-productive effects for use in bread and other baked goods. It has been found that when soft, small pellets of encapsulated PUFA's are incorporated into doughs or batters for production of baked goods such as bread, the pellets quickly dissolve in the dough or batter during mixing of the ingredients to obtain a homogeneous dough or batter, during dough kneading, and during baking. In the dough or batter making process, the dough or batter moisture and shear and mixing forces that are applied during mixing and/or kneading lead to moisture or water penetration into the omega-3 pellets causing more softening and smearing of the pellets until they have completely disappeared and mixed into the dough or batter. With complete dissolving, the physical and chemical protection of the omega-3 oil that was initially provided by the encapsulation matrix is lost causing a rapid deterioration by oxidation and sensorial failure during the shelf life of the baked goods such as bread which is targeted to be 14 days at room temperature after baking. While increasing the pellet size may result in a portion of the larger pellet surviving the dough mixing process, the portion which does dissolve results in an undesirable fishy taint in taste and odor attributes in the baked goods. Also, large pellets which are highly visible to the naked eye may detract from a desirable uniform cellular crumb structure or may be incompatible with a soft texture and desirable mouthfeel for baked goods such as breads, cakes, and muffins.

The present invention provides small pellets of encapsulated oils containing readily oxidizable polyunsaturated fatty acids such as omega-3 oils incorporated into a starch and protein matrix which can be used in or processed and incorporated into or added to baked good doughs and batters, baked goods such as breads, snacks, cookies, rolls, crackers, biscuits, cakes, muffins, and breadsticks, without smearing or dissolution of the pellets in the dough, batter, or baked good to provide edible products with extended shelf life, antioxidant stability against fishy taint, and mal-taste and mal-odors.

### SUMMARY OF THE INVENTION

In a first aspect of the invention, an encapsulated product for baked goods which can be incorporated into a baked good dough or batter without substantial smearing or dissolution of the encapsulated product in the dough or batter, comprises oil droplets comprising at least one polyunsaturated fatty acid, a film-forming component comprising a protein which coats the oil droplets, a matrix material encapsulating the film-coated oil droplets, a liquid plasticizer which plasticizes the matrix material, and an acidic antioxidant dispersed throughout the plasticized matrix material. The matrix material comprises a starch component and a protein component, wherein the amount of protein in the matrix material is from about 35% by weight to about 75% by weight, preferably from about 45% by weight to about 65% by weight, based upon the weight of said matrix material. The protein content of the encapsulated product is from about 25% by weight to about 65% by weight, preferably from about 40% by weight to about 60% by weight, based upon the weight of the encapsulated product. The protein component hardens the encapsulated product and prevents substantial smearing and dissolution of the encapsulated product and release of the oils during mixing of the encapsulated product in a baked good dough or batter, and in the baked good. The starch component helps to avoid a rubbery consistency and texture and promotes extrudability.

Additionally, the acidic antioxidant is distributed throughout the matrix material and helps to prevent oxidation of the at least one polyunsaturated fatty acid; and the production of a fishy taint or malodors and mal-flavors. The amount of the acidic antioxidant may generally be from about 0.5% by weight to about 10% by weight, preferably from about 1% by weight to about 5% by weight, most preferably from about 2% by weight to about 4% by weight, based upon the weight of the encapsulated product. The amount of oil may range from about 5% by weight to about 20% by weight, based upon the weight of the encapsulated product. A liquid polyol may optionally be employed to mobilize the acidic antioxidant in the matrix material in amounts which do not excessively soften the encapsulated product so as to cause smearing or dissolution of the encapsulated product during dough or batter mixing and production, and baking. The encapsulated product may be in the form of discrete particles or pellets having a diameter of from about 0.2 mm to about 3.0 mm, preferably from about 0.4 mm to about 0.9 mm. In embodiments of the invention, the encapsulated product may have a storage or shelf stability of at least about 6 months, preferably at least 12 months under nitrogen flushed room temperature conditions or refrigerated conditions.

In additional aspects of the invention, baked good dough or batter, baked good mixes, baked good kits, packages, and baked goods comprising the encapsulated product are provided. Exemplary baked goods which may contain the encapsulated product are breads, biscuits, rolls, buns, cakes, muffins, breadsticks, pretzels, pizza, cookies, crackers, and snacks. Even though vigorous mixing and kneading, as in bread dough production may be employed, and high moisture content doughs or batters may be involved, the encapsulated products unexpectedly do not smear or dissolve in the dough or batter, or in the baked good. In embodiments of the invention, the encapsulated products may be included in baked good mixes such as bread mixes, cake mixes, cookie mixes, and muffin mixes, and baking flour. In embodiments of the invention, the encapsulated products of the present invention may be packaged in a high moisture and/or high oxygen barrier material in the form of a bag or pouch or other package which is nitrogen flushed. The package of encapsulated product may be sold as such or may be included in a baked good product kit or mix with another package containing a premix of baked good ingredients comprising flour.

In a further aspect of the invention, a method for encapsulating an oil comprising a polyunsaturated fatty acid for incorporating into a baked good without substantial smearing and dissolution of the encapsulated product during mixing of the encapsulated product in a baked good dough or batter comprises forming an oil-in-water emulsion comprising at least one polyunsaturated fatty acid and a film-forming component comprising a protein. The oil-in-water emulsion is admixed with a matrix material, a liquid plasticizer for plasticizing the matrix material, and an acidic antioxidant for preventing oxidation of the at least one polyunsaturated fatty acid. The matrix material comprises a starch component and a protein component with the amount of protein in the matrix material being from about 35% by weight to about 75% by weight, preferably from about 45% by weight to about 65% by weight, based upon the weight of the matrix material. The admixing is conducted so as to obtain a formable mixture where the matrix material contains the acidic antioxidant and encapsulates oil droplets of the oil-in-water emulsion. The formable mixture is formed into pieces, and the pieces are dried to obtain dried pieces of encapsulated product, wherein the protein content of the encapsulated product is from about 25% by weight to about 65% by weight, preferably from about 40% by weight to about 60% by weight, based upon the weight of the encapsulated product. In embodiments of the invention, the starch component and the protein component may be preblended to obtain the matrix material, and the matrix material may be admixed with the acidic antioxidant, the emulsion, and the plasticizer to at least substantially plasticize the matrix material, and to substantially uniformly distribute the antioxidant throughout the matrix material.

In embodiments of the invention, when commercial mixing methods are employed and/or with lower moisture content doughs, such as bread doughs produced on commercial scale dough mixing and kneading equipment, and cookie doughs, the amount of protein in the matrix is from about 25% by weight to about 77.5% by weight, preferably from about 30% by weight to about 77.5% by weight, more preferably from about 30% by weight to about 65% by weight, based upon the weight of the matrix material. Also, the protein content of the encapsulated product when mixing is performed with a lower moisture content dough, such as a cookie dough, and/or when using commercial scale mixing methods and equipment, is from about 15% by weight to about 65% by weight, preferably from about 20% by weight to about 65% by weight, more preferably from about 20% by weight to about 55% by weight, based upon the weight of the encapsulated product.

In another aspect of the invention, a method for incorporating an oil comprising a polyunsaturated fatty acid into a baked good comprises admixing the encapsulated product with baked good dough or batter ingredients comprising flour and water to obtain a dough or batter without substantial smearing and dissolution of the encapsulated product in the dough or batter. The doughs or batters may be baked to obtain baked goods such as breads, biscuits, rolls, buns, cakes, muffins, breadsticks, pretzels, pizza, cookies, crackers, and snacks, without substantial smearing and dissolution of the encapsulated product in the baked goods. In embodiments of the invention, baked goods, such as breads, may have an omega-3 fatty acid concentration, such as a concentration of docosahexaenoic acid (DHA), of at least about 10 mg per serving, preferably at least about 16 mg per serving, most preferably at least about 32 mg per serving, and may have shelf stabilities after baking which are the same as or greater than the shelf life of the baked good without the incorporated polyunsaturated fatty acids.

### BRIEF DESCRIPTION OF THE DRAWINGS

The present invention is further illustrated by the accompanying drawings wherein:

FIG. 1 is a graph showing the relationship between the encapsulated product particle size, protein content, and smearing or dissolution of the encapsulated product when admixed with bread dough ingredients to obtain a bread dough.

FIG. 2 shows an overlay plot of sensorial and physical stability of pellets as a function of glycerin content based upon the weight of the encapsulated or final product, and wheat protein content of the matrix, based upon the weight of the dry matrix.

### DETAILED DESCRIPTION OF THE INVENTION

The present invention generally relates to baked goods, such as breads, containing readily oxidizable polyunsaturated fatty acids, and more particularly, to baked goods containing omega-3 fatty acids, and methods for making the baked goods where the free fatty acids such as omega-3 fatty acids are stabilized against oxidation, and the production of fishy taints or mal-odors and mal-taste. The use of encapsulated products containing the readily oxidizable polyunsaturated fatty acids encapsulated in a matrix material having critical amounts of a protein component and a starch component unexpectedly avoids substantial smearing and dissolving of the encapsulated product in the dough or batter during dough or batter production and during baking which results in oxidative instability, and fishy taints, and provides a non-rubbery texture and mouthfeel which are compatible with the baked good texture. In embodiments of the invention, the baked goods may have shelf stabilities after baking which are the same as or greater than the shelf life of the baked good without the incorporated polyunsaturated fatty acids. For example, the shelf life of bread, rolls, buns, and muffins, and other high moisture, soft baked goods may normally be about 14 days after baking. The same type of baked good, such as a bread, which is produced in accordance with the present invention may have a shelf life of at least 14 days after baking even though it contains a high amount of readily oxidizable polyunsaturated fatty acids. In other embodiments of the invention, baked goods such as crisp cookies or snacks, or other low moisture content products may have a shelf life of at least about 6 months after baking even though the baked good contains a high amount of readily oxidizable polyunsaturated fatty acids.

The encapsulated product for baked goods which can be incorporated into a baked good dough or batter without substantial smearing or dissolution of the encapsulated product in the dough or batter, contains oil droplets comprising at least one polyunsaturated fatty acid, such as omega-3 fatty acids, and a film-forming component comprising a protein which coats the oil droplets. The matrix material of the present invention encapsulates the film-coated oil droplets, and a liquid plasticizer plasticizes the matrix material. In addition, an acidic antioxidant is dispersed throughout the plasticized matrix material. The matrix material comprises a starch component and a protein component, wherein when mixing is performed with a retail scale bread maker or bread machine, which generally employs longer mixing times, less intense mixing, and higher moisture content doughs, the amount of protein in the matrix material is critically from about 35% by weight to about 75% by weight, preferably from about 45% by weight to about 65% by weight, based upon the weight of the matrix material. The protein content of the encapsulated product, when mixing is performed with a retail scale bread maker or bread machine, is critically from about 25% by weight to about 65% by weight, preferably from about 40% by weight to about 60% by weight, based upon the weight of the encapsulated product.

Upon additional experimentation during scale-up it has been found that lower amounts of protein and higher amounts of glycerin may be employed: 1) when using commercial scale bread making equipment and bread making methods, in particular commercial dough mixing and kneading equipment, which generally employ shorter mixing times, more intense mixing, and lower moisture content doughs, and/or 2) with doughs which generally employ low moisture contents, such as cookie doughs. It has been found that when commercial mixing methods are employed and/or with the lower moisture content doughs, the amount of protein in the matrix is critically from about 25% by weight to about 77.5% by weight, preferably from about 30% by weight to about 77.5% by weight, more preferably from about 30% by weight to about 65% by weight, based upon the weight of the matrix material. Also, the protein content of the encapsulated product when mixing is performed with a lower moisture content dough and/or when using commercial scale mixing methods and equipment is critically from about 15% by weight to about 65% by weight, preferably from about 20% by weight to about 65% by weight, more preferably from about 20% by weight to about 55% by weight, based upon the weight of the encapsulated product.

For example, in embodiments of the invention, for the production of low moisture content doughs, such as cookies, and/or for the commercial scale production of doughs using commercial mixing equipment and methods, such as the commercial scale production of bread doughs, the amount of protein employed in the matrix may be from about 25% by weight to about 35% by weight, based upon the weight of the matrix material, and the protein content of the encapsulated product or final product may be from about 15% by weight to about 25% by weight, based upon the weight of the encapsulated or final product.

The protein component hardens the encapsulated product and prevents substantial smearing and dissolution of the encapsulated product and release of the oils during mixing of the encapsulated product in a baked good dough or batter, and in the baked good. The starch component helps to avoid a rubbery consistency and texture caused by too much protein, and promotes extrudability. The starch component reduces stickiness caused by the protein component which would make extrusion or machining of the plasticized mass difficult or impossible, especially when small extrusion die apertures are employed for production of small pellets. The acidic antioxidant is distributed throughout the matrix material and helps to prevent oxidation of the at least one polyunsaturated fatty acid; and the production of a fishy taint or malodors and mal-flavors. A liquid polyol may optionally be employed to mobilize the acidic antioxidant in the matrix material in amounts which do not excessively soften the encapsulated product so as to cause smearing or dissolution of the encapsulated product during dough or batter mixing and production, and during baking.

The encapsulated products exhibit prolonged shelf stability during storage before incorporation into a dough or batter, as well as after incorporation into a dough or batter, and after baking of the dough or batter into a baked good, without substantial oxidation of the readily oxidizable polyunsaturated fatty acids, such as omega-3 fatty acids. In embodiments of the invention, the encapsulated product may have a storage or shelf stability of at least about 6 months, preferably at least 12 months under nitrogen flushed room temperature conditions or refrigerated conditions. The encapsulated products may be included in baked good mixes such as bread mixes, cake mixes, cookie mixes, and muffin mixes, and baking flour. In embodiments of the invention, the encapsulated products of the present invention may be packaged in a high moisture and/or high oxygen barrier material in the form of a bag or pouch or other package which is nitrogen flushed. The package of encapsulated product may be sold as such or may be included in a baked good product kit or mix with another package containing a premix of baked good ingredients comprising flour. Exemplary baked goods which may contain the encapsulated product are breads, biscuits, rolls, buns, cakes, muffins, breadsticks, pretzels, pizza, cookies, crackers, and snacks.

Readily oxidizable oils which may be employed in the present invention may comprise, for example, castor oil, algae-based oil or oil derived from algae, flax oil or flax seed oil, fish oil, seed oil, oil from microorganisms, or any other oil containing polyunsaturated fatty acids (PUFA) such as omega-3 fatty acids, eicosapentaenoic acid (EPA), docosahexaenoic acid (DHA), docosapentaenoic acid, and linolenic acid, alpha-linolenic acid, conjugated linolenic acid, gamma linolenic acid, and omega-6 fatty acids. In embodiments of the invention the readily oxidizable oils may be plant oils from plants genetically modified to include a polyunsaturated fatty acid or increased amounts thereof above levels present in oils from non-genetically modified plants, such as soy oil, sunflower oil, canola oil, rapeseed oil, or corn oil. The oils or fruit products may also contain other readily oxidizable oils such as fat soluble vitamins such as vitamins A, D, E, and K, cod liver oil, flavorants, flavor oils, fragrances, active-ingredient containing extracts, e.g. chlorophyll or herbals, phytosterols, agricultural and pharmaceutical and other bioactive components soluble in oil, and mixtures thereof. In embodiments of the invention, the readily oxidizable oil may be any oil derived from any vegetable, animal, marine life, or microorganism which contains a substantial amount, for example at least 5% by weight of a readily oxidizable component. Examples of oils which may contain a substantial amount of a readily oxidizable component are oils derived from soybeans and corn, sunflower oil, rapeseed oil, walnut oil, wheat germ oil, canola oil, krill oil, oil derived from yeast, black currant seed oil, sea buckthorn oil, cranberry seed oil, and grape seed oil. Purified fish oils may, for example, have an omega-3 fatty acid content (DHA, EPA) of from about 25% by weight to about 49% by weight. Flax oil may have an omega-3 fatty acid content as high as about 71% by weight.

In embodiments of the invention, a readily oxidizable oil, such as an omega-3 oil, may be included in an amount of up to about 25% by weight, for example from about 5% by weight to about 20% by weight, preferably from about 8% by weight. In addition, in embodiments of the invention, the amount of oil employed may provide a Food & Drug Administration (FDA) minimum recommended daily requirement of polyunsaturated fatty acids such as omega-3 fatty acids or a substantial percentage of a recommended daily value (DV), or an amount or concentration of omega-3 oil in the encapsulated product which may be needed to meet certain food regulations for various baked goods. For example, in embodiments of the invention, baked goods, such as breads, may have an omega-3 fatty acid concentration, such as a concentration of docosahexaenoic acid (DHA), of at least about 10 mg per serving, preferably at least about 16 mg per serving, most preferably at least about 32 mg per serving. In preferred embodiments of the invention, the encapsulated products may contain an amount of oil which is sufficient to provide breads or other baked goods having a concentration of docosahexaenoic acid (DHA) of at least about 32 mg per 50 g serving size.

The matrix material of the present invention is plasticizable and includes a protein component and a starch component. The protein component may be a vegetable protein, dairy protein, animal protein, a protein concentrate, and mixtures thereof. Exemplary protein components which may be employed are wheat protein isolates, vital wheat gluten, gelatin, casein, caseinates, such as sodium caseinate, potassium caseinate, or calcium caseinate, soy protein isolates, whey protein isolates, and mixtures thereof. The protein components generally have a protein content of at least about 60% by weight, preferably at least about 70% by weight, most preferably at least about 85% by weight protein, based upon the weight of the protein component. A preferred protein component for use in the present invention is a wheat protein isolate, such as ARISE 5000 produced by MGP Ingredients, Inc., Atchison, Kans. ARISE 5000 has a protein content of greater than 90% by weight (N×6.25, d.b.), an ash content of about 1% by weight, is more extensible, less elastic (gliadin-like), a hydrated pH which is acidic with a pH of about 4, and is sulfite treated with a residual sulfite content of about 45 ppm.

The starch component of the plasticizable matrix material may be a high gluten content flour, durum wheat or semolina, pregelatinized or modified starch, corn flour, wheat flour, rice flour, barley flour, oat flour, rye flour, heat treated flours, such as heat treated wheat flour, and mixtures thereof. The modified starches or pregelatinized starches may be derived from corn, wheat, rice, potato, tapioca, or high amylose starch. Sources of starch which may be used include flours from grains such as corn, wheat, durum wheat, rice, barley, oat, or rye, and mixtures thereof. Preferred starch components for use in the present invention are durum wheat and semolina. The plasticizable starch components generally have a starch content of at least about 75% by weight, preferably at least about 80% by weight, most preferably at least about 85% by weight starch, based upon the weight of the starch component.

Durum products or ingredients which may be used in the present invention include durum semolina, durum granular, durum flour and mixtures thereof. Durum flour is preferred. Durum semolina is the purified or isolated middlings of durum wheat prepared by grinding and bolting cleaned durum wheat to such fineness that when tested by the method prescribed in 21 CFR' 137.300(b)(2), it all passes through a No. 20 U.S. sieve, but not more than 3 percent passes through a No. 100 U.S. sieve. The semolina is freed from bran coat or bran coat and germ to such an extent that the percent of ash therein, calculated to a moisture-free basis, is not more than 0.92 percent. The durum granular product is a semolina to which flour has been added so that about 7% passes through the No. 100 U.S. sieve. Durum flour has not less than 98 percent passing through the No. 70 U.S. sieve.

In embodiments of the present invention, the amount of the plasticizable matrix material, or the total amount of the protein component and the starch component, may be from about 60% by weight to about 85% by weight, preferably from about 65% by weight to about 80% by weight, based on the weight of the encapsulated product.

In embodiments of the invention, substantially non-plasticizable matrix components may be used to facilitate processing in amounts which do not excessively soften the encapsulated product so as to cause smearing or dissolution of the encapsulated product during dough or batter mixing and production, and baking. Such substantially non-plasticizable matrix materials may comprise substantially non-gelatinized starch, such as raw or native starch, as well as carbohydrates which have a lower molecular weight than starches, bulking agents, fiber or other, inert materials, such as cellulose, fiber or hemi-cellulose. Sources of starch which may be used include starches from grains such as corn, wheat, durum wheat, rice, barley, oat, or rye, and mixtures thereof.

Exemplary acidic antioxidants or proton-donating antioxidants which may be employed in effective amounts in the matrix material are organic acids such as L-cysteine, acetic acid, tartaric acid, lactic acid, malic acid, citric acid, fumaric acid, propionic acid, tannic acid, ascorbic acid, iso-ascorbic acid, and erythorbic acid, tocopherol, catechin, salts thereof, isomers thereof, derivatives thereof, and mixtures thereof. Exemplary salts which may be employed are alkaline earth metal and alkali metal salts, such as calcium, potassium, and sodium salts of ascorbic acid, erythorbic acid, and L-cysteine, and phenolic salts. Exemplary derivatives include acid anhydrates, esters, amides, and lipophilic acids. The preferred acidic antioxidants for use in the matrix material are organic acids such as citric acid, ascorbic acid and erythorbic acid, most preferably erythorbic acid or ascorbic acid. In embodiments, the antioxidant may be added to the matrix material, to a plasticizer that is mixed with the matrix material, or to a plasticizer during emulsion preparation and formation.

The amount of the acidic antioxidant may generally be from about 0.5% by weight to about 10% by weight, preferably from about 1% by weight to about 5% by weight, most preferably from about 2% by weight to about 4% by weight, based upon the weight of the encapsulated product.

The plasticizer or combination of plasticizers for plasticizing the plasticizable matrix material facilitates mixing and dispersing and mobilizing of the acidic antioxidant throughout the matrix material. Water is a preferred plasticizer for use in the present invention. The plasticizer may contain at least one liquid which solubilizes the acidic antioxidant and is retained in the pellet after drying in a sufficient amount to prevent substantial crystallization of the acidic antioxidant, and provide mobility to the acidic antioxidant in the dried pellet. It is assumed that the mobility provided should be such so that the acidic antioxidant can react with any ambient oxygen which enters the pellet interior or matrix material to prevent the oxygen from penetrating into the film-coated oil droplets. Also, the plasticizer should preferably keep the acid antioxidant solubilized and prevent substantial crystallization in the dried pellet. The mobility should enable the acidic antioxidant to donate protons to terminate any radicals from the fatty acids and/or react with any malodorous amines given off by fish oils. Exemplary of mobilizing plasticizers which may be employed with the acidic antioxidant are water, polyols or glycols such as glycerol, propylene glycol, and polyethylene glycol, sugar alcohols such as sorbitol, monosaccharides, and di-saccharides such as fructose, and dextrose, and mixtures thereof.

While water may be employed to plasticize the matrix material as well as to solubilize the acidic antioxidant, drying of the pellets to achieve a shelf stable water activity of less than about 0.7 generally results in substantial crystallization and immobilization of the acidic antioxidant in the pellet. However, it has been found that the use of high amounts of plasticizers, which soften the encapsulated products, tend to promote smearing or dissolution of the encapsulated particles, and may not be needed in the high protein content encapsulated products. It is believed that the high amounts of protein employed prevents substantial access of water and oxygen to the readily oxidizable polyunsaturated fatty acids. Accordingly, water or aqueous solutions which enable forming a dough, such as fruit juice, may be employed as a plasticizer in the matrix to facilitate mixing and initial dispersing and homogenization of the antioxidant. However, a less volatile, liquid plasticizer or softener such as a polyol may also be optionally employed to achieve acidic antioxidant mobility in the matrix material in the final pellet, in amounts which do not excessively soften the encapsulated product so as to cause smearing or dissolution of the encapsulated product during dough or batter mixing and production, and baking. Increasing the amount of glycerin is desired to improve sensorial and chemical or oxidative stability of pellets, but tends to result in less physical stability or smearing or dissolving of pellets in high moisture content doughs such as bread doughs. Physical stability may be increased at higher glycerin contents by increasing the protein content in the matrix, and encapsulated product. For example, at least one liquid polyol for providing mobility to the acidic antioxidant in the plasticized matrix material, may optionally be employed in an amount of less than or equal to about 20% by weight, for example from about 5% by weight to about 20% by weight, preferably less than about 15% by weight, based upon the weight of the encapsulated product, for low moisture content baked good doughs, such as cookie doughs. For higher moisture content doughs, such as bread doughs, the amount of the optional at least one liquid polyol may be less than about 10% by weight, for example less than about 5% by weight, preferably from about 1.0% by weight to about 7.5% by weight, based upon the weight of the encapsulated product.

Water or aqueous solutions employed as a plasticizer for the matrix material may be admixed with the optional non-aqueous plasticizer or softener or it may be separately added to the matrix material. Water which is used to form the oil-in-water emulsion also serves to plasticize the plasticizable portion of the matrix material.

In embodiments of the invention, rate release controlling agents may be added to the admixture of the present invention, including components that may manage, control or affect the flow, diffusion or distribution of water or aqueous-based compositions into and within the final product particles. The additional ingredient or component for controlling the rate of release of the encapsulant may be a hydrophobic agent such as a fat, oil, wax, fatty acid, or emulsifier which increases the hydrophobicity of the matrix. The increased hydrophobicity helps to prevent or delays penetration of water or gastric juice into the matrix.

In embodiments of the invention, one or more flavors such as a fruit flavor or vanilla or vanillin or other taste modifying components, such as cocoa powder or cinnamon powder may be added to the matrix material to aid in masking off odors and off flavors. Exemplary amounts of those components or flavors which may be used may range up to about 20% by weight, for example up to about 5% by weight, based upon the weight of the matrix material.

In embodiments of the invention, titanium dioxide or zinc oxide may be added to the matrix material to improve pellet shape and as a whitener to lighten the color of the pellets. Exemplary amounts of whitener which may be used may range up to about 10% by weight, based upon the weight of the matrix material.

The pellets are produced by first reducing the water content of a stabilized emulsion so that the film-forming component forms a film around the oil droplets and encapsulates the encapsulant. After homogenization, the water content of the emulsion may be reduced by admixing the emulsion with the plasticizable matrix material to thereby encapsulate the film-coated oil droplets within the plasticized matrix material. In embodiments of the invention, the pH of the pellets may range from about 2.5 to about 8.

Improved dispersion and encapsulation of active, sensitive encapsulant materials in discrete shelf-stable particles is obtained by pre-emulsification of the encapsulant. The encapsulant is incorporated into or forms the oil phase of an oil-in-water emulsion. The oil-in-water emulsion containing the encapsulant is admixed with the plasticizable matrix material to encapsulate the encapsulant within the matrix material. Using matrix materials which are plasticizable by the emulsion or the aqueous component of the emulsion, results in encapsulation of the encapsulant within a plasticized matrix material. The encapsulant or sensitive, active component it may be directly emulsified with the water or aqueous liquid plasticizer.

In embodiments of the present invention, the aqueous component, such as water or an acidic aqueous solution, such as a 0.2N acetic acid in water, may be admixed with the film-forming component, such as a protein, to obtain an aqueous solution. The film-forming component helps to stabilize the emulsion, retain oil droplet size, inhibit diffusion of the oil component and encapsulant to the particulate or pellet surface, and to inhibit contact of rancidity-causing oxygen with the oil component.

The aqueous solution, such as an aqueous protein solution, may have a film-forming component content, or protein content, of from about 1% by weight to about 50% by weight, preferably from about 5% by weight to about 25% by weight, most preferably from about 8% by weight to about 15% by weight, based upon the total weight of the aqueous component, such as water, and the film-forming component, such as protein.

In embodiments of the invention, the film-forming component is water soluble and may comprise a hydrophobic or oleophilic portion, such as a film-forming protein, so that it may concentrate at the oil and water interface. Film-forming components which may be employed include, but are not limited to, proteins; carbohydrates; hydrocolloids, such as alginates, carrageenans, and gums; starches, such as modified starch and starch derivatives; or mixtures thereof. Proteins are the preferred film-forming components for use in the emulsification. Exemplary proteins which may be employed are one or more vegetable proteins, dairy proteins, animal proteins, or protein concentrates, such as proteins stemming from milk, whey, corn, wheat, soy, or other vegetable or animal sources. Preferred proteins for use in the present invention are dairy proteins such as caseinates and whey protein isolates, and wheat protein isolates, such as gluten. Caseinates, such as sodium caseinate, potassium caseinate, calcium caseinate, and ammonium caseinate are most preferred proteins for use in the preparation of the film coated oil droplets.

The caseinates are readily soluble proteins, and provide lower viscosity aqueous phases compared to viscosities obtained with other proteins, such as whey protein isolates. The lower viscosity facilitates emulsification and homogenization with the oil phase, and the attainment of small oil droplet sizes, and unexpectedly superior microencapsulation efficiency.

Microencapsulation efficiency (ME) may be calculated as follows:

ME=[(Total oil−Free oil)/Total oil]×100[%]

The quantitative determination of the total oil content of the samples may be accomplished by acid hydrolysis followed by extraction according to the WEIBULL-STOLDT method. The free, accessible or non-encapsulated oil in the extrusion pellets may be determined according to a modified method after SANKARIKUTTY et al., “Studies on Microencapsulation of Cardamom Oil by Spray Drying Technique”, Journal of Food Science and Technology, vol. 6, pp. 352-356 (1988), HEINZELMANN et al., “Microencapsulation of Fish Oil by Freeze-drying Techniques and Influence of Process Parameters on Oxidative Stability During Storage”, European Food Research and Technology, vol. 211, pp. 234-239 (2000), McNAMEE et al., “Emulsification and Microencapsulation Properties of Gum Arabic”, Journal of Agricultural and Food Chemistry, vol. 46, pp. 4551-4555 (1998), McNAMEE et al., “Effect of Partial Replacement of Gum Arabic with Carbohydrates on its Microencapsulation Properties”, Journal of Agricultural and Food Chemistry, vol. 49, pp. 3385-3388 (2001), and HOGAN et al., “Microencapsulation Properties of Sodium Caseinate”, Journal of Agricultural and Food Chemistry, vol. 49, pp. 1934-1938 (2001). A sample with a total oil content of approximately 1 g (e.g. 7 g of extrusion pellets with an oil content of approximately 15%) may be transferred in 100 ml petroleum ether (boiling point: 60-80° C.) and stirred with a magnetic stirrer for exactly 15 minutes at ambient temperature. After the following filtration (Schleicher & Schuell 595) the filtrate may be transferred into an extraction apparatus after SOXHLETT and the solvent may be evaporated at 80° C. The received oil residue may be dried in a drying oven (Heraeus 6060, Kendro Laboratory Products, Hanau, Germany) at 105° C. to constant (or minimum) weight and quantified gravimetrically (approximately 1 hour). Under the conditions of the pre-described method the free oil is completely removed from the pellets already after 15 minutes. An increase of the agitation time up to 60 minutes did not entail significant changes. Compared with other solvents, i.e., alcohols, ethers, water and/or mixtures thereof, the use of petroleum ether results in the highest content of free oil. In embodiments of the present invention, the microencapsulation efficiency may be greater than about 85%, preferably greater than about 90%.

The protein may be at least substantially or completely hydrated and denatured prior to admixing with the oil component to avoid clumping and to facilitate subsequent pumping through the homogenizer. Hydration can be accomplished by preparing the solution either immediately before use or up to a day before use and storing it under refrigerated conditions to permit any foam or froth resulting from the mixing to settle.

The protein, such as whey protein isolate (WPI), can be kept in either the native form or can be denatured prior to emulsification with the fish oil. Denaturation can be achieved by heating the dispersed WPI solution to about 80° C.-90° C. and holding for 30 minutes. Denatured WPI solutions appear to form better films than native WPI solutions and may add to the stability of the final encapsulated oil. In either case, the whey protein isolate can serve as an emulsifier in the final emulsion with oil. Again, it is desirable to allow the WPI solutions (native or denatured) to fully hydrate and cool under refrigerated conditions, for example at about 40° F., prior to use.

In embodiments of the present invention, the emulsion may be made by admixing one or more optional ingredients with the aqueous film-forming component solution, such as the aqueous protein solution, using a high shear mixer such as an ULTRA-TURRAX ROTOSOLVER high shear mixer or other mixer with adequate shear. Such optional ingredients include a film-softening component or plasticizer, a non-acidic antioxidant, an acidic antioxidant, a flavor, and an emulsifier in amounts which do not adversely affect viscosity for emulsification and homogenization and the achievement of small oil droplet sizes and a stable emulsion. When a readily oxidizable encapsulant such as omega-3 fatty acids is to be encapsulated, mixing of the optional ingredients with the emulsion is preferably conducted in an atmosphere which is at least substantially free of oxygen, such as under a nitrogen blanket or inert gas blanket. Preferably to prevent and/or minimize oxygen exposure, a nitrogen blanket can be applied in subsequent locations when the fish oil is directly exposed to the atmosphere.

A film-softening component or plasticizer for reducing brittleness and preventing cracking of the film formed from the film-forming component which may be optionally added in the emulsion step include monosaccharides and disaccharides, such as sucrose and fructose, and polyols such as glycerol, and polyethylene glycol in amounts which do not result in substantial pellet smearing or dissolution.

For the encapsulation of readily oxidizable components such as polyunsaturated fatty acids, such as omega-3 fatty acids in oils from fish, algae, flax, seeds, microorganisms or other sources, the emulsion is preferably prepared in an atmosphere substantially free of oxygen, such as a nitrogen blanket, and a non-acidic antioxidant or an acidic antioxidant may optionally be added in the emulsion step to the aqueous phase or to the oil phase. Exemplary antioxidants which may be employed are L-cysteine and its salts, ascorbic acid and salts thereof, erythorbic acid and salts thereof, tocopherol, catechin, TBHQ, such as Grindox 204, phenolics, natural antioxidants such as grape seed extract which contain antioxidant phenolics, and nut fibers, such as almond fiber, and mixtures thereof. TBHQ may or may not be present in the oil employed as a raw material, but even if present, may be added additionally in the oil prior to emulsification. For example, TBHQ may be added to the oil in an amount of about 10 ppm to about 1200 ppm, more preferably from about 600 ppm to about 1000 ppm, based upon the weight of the oil component. Mixed tocopherols may be added to the oil at concentrations of from about 10 ppm to about 1000 ppm. In embodiments of the invention, the amount of the optional antioxidant employed in the emulsion step may range from about 10 ppm by weight to about 10,000 ppm by weight, for example from about 50 ppm by weight to about 1,000 ppm by weight, or about 100 ppm by weight, based upon the weight of the oil component.

An acidic antioxidant, a non-acidic antioxidant, or a film softening component or plasticizer may optionally be employed in the emulsion. In embodiments, the optional antioxidant employed in the emulsion may be the same as or different from any antioxidant that may be employed in the matrix. In embodiments of the invention, it is preferable to only employ an acidic antioxidant in the matrix material. The acidic antioxidant in the matrix material serves to prevent oxidation of the oxidizable component in the film-coated oil droplets. Also, optional mobilized plasticizer in the matrix material migrates to the film forming component and helps to reduce its brittleness.

In embodiments, the acidic antioxidant may be added to the matrix material to avoid possible deleterious interaction between the protein and the acidic antioxidant. In other embodiments of the invention, this deleterious interaction may be overcome by adding the protein (such as sodium caseinate) to an already-acidified medium in which the pH of the medium is above or below the protein isoelectric point (e.g., for sodium caseinate about 4.4 to about 4.6).

Any compatible flavor may optionally be added to the oil phase to mask off-flavors and off-odors in the oil and to help chemically stabilize oil. The flavor may be added at a level ranging from about 0.1% by weight to about 25% by weight, for example from about 1% to by weight to about 25% by weight, preferably about 0.5% by weight to about 15% by weight, for example, from about 10% by weight to about 15% by weight, more preferably about 1% by weight to about 5% by weight, for example, from about 2% by weight to about 5% by weight, based upon the weight of the oil phase.

The oil phase and the aqueous phase components may be admixed in the high shear mixer, such as an ULTRA-TURRAX ROTOSOLVER for about 10 minutes prior to high pressure multi-stage homogenization.

Once all of the ingredients for making the emulsion are admixed, the resulting emulsion or combination of ingredients may be run through a homogenizer. The homogenizer total stage pressure may be from about 1 psig to about 30,000 psig (about 7 kPa to about 206850 kPa), generally at least about 2,000 psig (13790 kPa), preferably from about 4,000 psig to about 10,000 psig (about 27580 kPa to about 68950 kPa), most preferably from about 5,000 psig to about 7,000 psig (about 34475 kPa to about 48265 kPa). The homogenization may be performed in one or more stages, using one or more passes through each stage. For example, two stages and three passes may be employed for the homogenization step. In other embodiments, there may be as many as four discrete passes of the emulsion through the homogenizer, but more preferably there are two to three passes. This process can produce a stable emulsion with droplet sizes less than about 2.1 microns (90 percentile), preferably less than about 1 micron (90 percentile). It is preferable to minimize heat exposure during homogenization as much as possible and to keep a nitrogen blanket on all emulsion containers.

Pre-emulsifying of an encapsulant oil or an encapsulant-in-oil into water or an aqueous liquid plasticizer may be achieved using a multi-step high pressure homogenizer either alone or in combination with a colloid mill to obtain minimum droplet size. High pressure homogenization gives rise to small droplet sizes and may substantially improve the distribution and dispersion, and bioavailability of active, sensitive encapsulants within a matrix material. Encapsulation of the emulsion within a matrix material can then be carried out under controlled, low pressure and low temperature conditions to prevent coalescence, oil separation, and extruder surging while giving a soft formable mixture or dough comprising small droplets of an active, sensitive encapsulant dispersed throughout the dough or mixture. The dough or mixture may be cut or shaped and dried to yield substantially non-expanded, discrete shelf-stable particles or pellets exhibiting an improved release profile of active encapsulant materials. An encapsulant may optionally be included in the water phase of the emulsion. An emulsifier may optionally be included to facilitate production or stabilization of the emulsion.

In high-pressure homogenization, an oil encapsulant or encapsulant in-oil is mixed with water or an aqueous fluid to obtain small oil droplets. All, or at least substantially all, for example, at least about 90% of the oil droplets in the homogenized, stabilized emulsion and in the discrete particulates, pellets, or encapsulated products of the present invention may have oil droplet sizes of less than about 50 microns in diameter, preferably less than about 10 microns in diameter, more preferably less than about 2 microns in diameter, most preferably less than about 1 micron in diameter. In embodiments of the invention, the oil droplet diameters may be less than about 0.5 microns. The smaller the droplets, the more stable is the emulsion which allows the formation of a dough without substantial coalescence of the droplets and oil separation. Also, reduced coalescence and very fine dispersion may increase bioavailability of the encapsulant. Reduction in coalescence increases coating or encapsulation of the encapsulant by a continuous phase of plasticized matrix material, for example plasticized semolina or mixtures of semolina and native starch. Use of a film-forming component, which can also function like an emulsifier, for example a vegetable or animal protein or protein concentrate can stabilize the emulsion by forming a thin film around the oil droplets during emulsification processing. Non-film forming emulsifiers, monoglycerides, diglycerides, or triglycerides or mixtures thereof, or other molecules that are characterized as having a lipophilic and a hydrophilic part may be employed to enhance stabilization of an oil encapsulant inside an outer aqueous phase. The smaller, substantially non-coalesced droplets, do not protrude from the matrix material, thereby reducing surface exposure of the oil coated encapsulant to air.

The oil-in-water emulsions according to the present invention may optionally include an emulsifier in effective emulsifying amounts to aid in the stabilization of the emulsion. Conventional emulsifiers used in food and pharmaceutical products, such as mono-glycerides and di-glycerides, may be selected for use according to the present invention.

After homogenization, the water content of the emulsion is reduced so that the film-forming component forms a film around the oil droplets and encapsulates the encapsulant. The water content of the emulsion may be reduced by admixing the emulsion with the plasticizable matrix material to thereby encapsulate the film-coated oil droplets within the matrix material. The aqueous component, such as water, is adsorbed by or interacts with the matrix material to thereby increase the concentration of the film-forming component and to cause it to form a film and precipitate around the oil droplets. Thus, if microcapsules of the oil component and the film-forming component are obtained, the microcapsules are further encapsulated by the matrix component. Preferably, the matrix material comprises a plasticizable matrix material, such as flour from wheat or durum, rye, corn, buckwheat, barley, oat or other grains, which is plasticized by the aqueous component to thereby encapsulate the film-coated oil droplets within the plasticized matrix material. Admixing of the emulsion and the matrix material may be performed in a continuous dough mixer or in an extruder to form a dough.

In preferred embodiments, all or substantially all of the plasticizer may be the water or aqueous liquid contained in the oil-in-water emulsion encapsulant component and the optional mobilizing plasticizer used to dissolve the acidic antioxidant. Additional, separately added plasticizer for the matrix material, such as water, fruit juice or other aqueous plasticizers may be added to the matrix material to assist in the formation of a dough or to adjust its viscosity for formability. The formable mixture or dough of the present invention may have a total plasticizer content of from about 6% by weight up to about 80% by weight, preferably about 20% by weight to about 45% by weight of the product or dough of the present invention. When plasticizers are employed at high levels, for example above about 80% by weight, a thin low viscosity dough may result which cannot be cut immediately at the extrusion die. However, cutting the exiting dough ropes into individual pellets may be done by known mechanical means. Lower plasticizer contents, such as below about 5% may result in a dry product, which would be too fragile after forming and would fall apart. Low plasticizer contents, such as below about 5%, also makes a mixture or dough difficult to extrude unless a fat is present. Low plasticizer contents may also generate frictional heating during extrusion forming and would be detrimental to a heat sensitive encapsulant.

In embodiments of the invention, the total amount of water or the moisture content of the dough, from all sources including water in the emulsion, water in the antioxidant solution, and separately added water, may range up to about 80% by weight, for example up to about 35% by weight, based upon the weight of the dough. In exemplary embodiments of the invention, the doughs may have a total moisture content of from about 2% by weight to about 60% by weight. For example, in exemplary embodiments of the invention, low moisture content doughs, such as cookie doughs or cracker doughs, may have a moisture content of from about 2% by weight to about 20% by weight, based upon the weight of the dough. In other exemplary embodiments of the invention, high moisture content doughs, such as bread doughs, pizza doughs, snack doughs, cake doughs or batters, biscuit doughs, and doughs for making rolls, buns, muffins, breadsticks, and pretzels, may have a moisture content of from about 25% by weight to about 60% by weight, based upon the weight of the dough.

In the method of admixing the oil-in-water encapsulant emulsion component into a plasticizable matrix material of the present invention, droplet size is inversely proportional to stability. Accordingly, desirable droplet sizes in the formable mixture or dough of the present invention may range from about 0.5 microns to about 50 microns in diameter, preferably less than about 10 microns in diameter, more preferably less than about 2 microns, most preferably less than about 1 micron. As evidence of emulsion stability, the droplet diameters of the emulsion of the present invention remain substantially unchanged throughout the admixture of the emulsion with a matrix material to form a dough or formable mixture.

The admixing step of the present invention may be preferably carried out in an extruder to form an admixture of: 1) an oil-in-water encapsulant emulsion component, 2) a dry matrix material component which includes a plasticizable matrix material, an optional non-plasticizable matrix material, an optional rate release controlling agent, and an optional flavor 3) a solubilized acidic antioxidant solution or component which may include an acidic antioxidant, an optional mobilizing plasticizer or softener such as glycerol, and water, and 4) separately added water. Low extrusion pressures and temperatures are employed to avoid coalescence, oil separation and extruder surging. Generally, low viscosities are required to extrude at low pressures. However, increasing the viscosity tends to increase shear which can destroy an emulsion.

Low extrusion pressures help to prevent coalescence, prevent the separation of an emulsion and prevent extruder surging. To achieve low pressures, dough viscosity may be reduced by increasing the amount of plasticizer, such as water. However, the dough viscosity should be sufficiently high so as to allow for the attainment of a formable, cuttable mixture at the die. Desirable extruder pressures under which the formable mixture may be formed may range from about 14.5 psig to about 2175 psig (about 100 kPa to about 14997 kPa), preferably from about 29 psig to about 1450 psig (about 200 kPa to about 9998 kPa), more preferably from about 72.5 psig to about 725 psig (about 500 kPa to about 4999 kPa). In embodiments of the invention, die operating pressures may range from about 70 psig to about 800 psig (about 483 kPa to about 5516 kPa), generally from about 100 psig to about 300 psig (about 690 kPa to about 2069 kPa).

In making the formable mixture or dough of the present invention, it is preferable in the admixing method of the present invention to achieve a balance between shear, which reduces particle size on the one hand, and lower viscosity, which reduces shear on the other hand. Reducing droplet size reduces coalescence and ensures protection of each individual encapsulant droplet within the particles according to the present invention.

In embodiments of the present invention, a preblend or separate feeds of the matrix material comprising the protein component and the starch component may be added to the first barrel of an extruder, to which may be added the plasticizer/acidic antioxidant, followed by the pre-emulsified components, and optional glycerol in the second barrel, and then optionally added water may be injected into the third barrel of the upstream end of the extruder to achieve plasticization of the plasticizable matrix material without substantial coalescence, or oil separation or surging even at high oil contents. Mixing is continued towards the extruder die while optionally adjusting the product temperature for sufficient formability. The plasticizable matrix material is plasticized by the water or aqueous liquid, and the optional mobilizing plasticizer of the plasticizer/acidic antioxidant solution. The optional substantially non-plasticizable matrix component is not plasticized by the liquid plasticizers generally at a temperature of less than about 60° C., preferably less than 50° C., most preferably less than about 45° C., for example at room temperature, or down to about 0° C. Removal of liquid plasticizer prior to extrusion is not needed to adjust the viscosity of the mixture for formability. In embodiments of the invention, the extruder barrel temperatures may be maintained in a range of about −5° C. to about 25° C., preferably from about 5° C. to about 10° C. Generally, die operating temperatures may range from about 10° C. to about 50° C., for example from about 15° C. to about 30° C.

A formable mixture may be obtained without substantially gelatinizing or cooking the plasticizable matrix material or the optional substantially non-plasticizable matrix component. The plasticizable matrix material in the formable mixture may become glassy upon drying, even though it was not cooked or substantially gelatinized during plasticization to obtain the formable mixture. However, use of the non-aqueous mobilizing plasticizer or softener, such as glycerol, may desirably provide a non-brittle texture which is less prone to cracking, oil leakage, and ambient oxygen penetration. Also, the starch component reduces rubberiness and stickiness to facilitate extrusion through the dies.

In embodiments of the invention, the amount of the active component or encapsulant which may be encapsulated or embedded into the matrix may be from about 5% by weight to about 30% by weight, based on the total weight of the plasticizable matrix material of the formable mixture or dough of the present invention, or from about 5% by weight to about 20% by weight, preferably from about 8% by weight to about 15% by weight, based upon the weight of the encapsulated product.

The admixture or dough may be extruded through extrusion dies and cut or otherwise formed into pieces or pellets with no or substantially no expansion of the extrudate.

In embodiments of the invention, the dough may be extruded through circular die holes having a diameter ranging from 0.2 mm to 3 mm (preferably from about 0.4 mm to about 0.9 mm) and face cut to 0.2 mm to 3 mm (preferably about 0.4 mm to about 0.9 mm). For example, pellet dimensions of 0.5 mm (diameter)×0.5 mm (length) may be produced. The dough may be kept cold during extrusion, for example less than approximately 30° C.

A flow agent such as starch or calcium carbonate may be added at the cutter apparatus to maintain the discrete nature of the particles or pellets and to assist the air conveying of pellets as they may stick to one another at high extrusion moisture contents or with high matrix protein levels.

The matrix can be composed of one or several different ingredients, ranging from durum wheat flour, sodium or potassium caseinate, whey protein isolate, wheat protein (or protein from other animal or vegetable sources), heat-treated flour, such as heat-treated wheat flour, starch, alginate, to other hydrocolloids, etc. which provide added oxidation protection.

In embodiments of the invention, the freshly extruded pellets can contain an oil load between about 5% by weight to about 30% by weight, at moisture contents between approximately 15% to about 35% by weight, based on the total weight of the freshly extruded pellet.

The extrudate or pieces may then be surface dried using conventional drying equipment, such as a rotary dryer. The pellets can be conveyed to a long (˜2 ft ID×4 ft. long) rotating enrober with air blowing countercurrent to extrudate or pellet flow. Dehumidified air is preferred for more efficient drying. Hot air (dehumidified or ambient) up to approximately 280° C. can be used to surface dry the pellets. Generally, the air drying temperature may be from about 37° C. to about 82° C., but more preferred is an air temperature of about 50° C. to about 60° C. Surface drying facilitates optional subsequent coating. Even at elevated hot air temperatures, the product temperature at the exit of the enrober can still remain below approximately 100° F. (˜37.7° C.). In embodiments of the invention, up to about 10% by weight moisture or more, for example up to about 20% by weight, may be removed from the pellets during surface drying in the rotary dryer. Other conventional drying apparatus, such as fluid bed drying or static bed drying may also be employed.

In embodiments of the invention, the surface dried extrudate or pellets or pieces may optionally be coated or surface treated with a protective film or coating to either prevent early release or to enable controlled release of the encapsulant from the pellets or pieces. Surface drying after extrusion and before coating facilitates application of a protective coating solution. For instance, drier pellets can accept higher levels of coating before clumping or agglomeration could become an issue. The protective coating may be hydrophilic or oleophobic so as to inhibit outward migration of the oil component to the surface of the pellet where it would be subject to oxidation. Exemplary film-building substances or protective coatings which may be employed are a protein stemming from whey, corn, wheat, soy, or other vegetable or animal sources, such as aquazein (an aqueous corn protein solution), and denatured whey protein isolate solution (with or without a plasticizer such as sucrose or glycerol) a fat, such as melted chocolate fat, shellac, wax, film-forming starch solutions, alginates, other non-starch polysaccharides, an enteric coating, and mixtures thereof.

Denatured whey protein isolate films plasticized with sucrose are preferred for its function as an oxygen barrier. Other biopolymers that may be used in lieu of or in addition to denatured whey protein are soy protein isolate, modified food starch, hydroxymethylpropylmethylcellulose, and shellac. Exemplary polymer and plasticizer ratios which may be employed range from about 1:0.25 to about 1:3 parts by weight of polymer to plasticizer. For example, a coating or film composition for application to the surface dried pellets may be produced by heating a solution consisting of deionized water and whey protein to about 90° C. and holding at that temperature for about 30 minutes to denature the protein. The solution may then be cooled and the plasticizer, such as sucrose, may be added at a ratio of 1 part by weight protein to 3 parts sucrose. The formula of the coating solution may be 5% by weight denatured whey protein, 15% by weight sucrose, and 85% by weight de-ionized water.

The film-building substance or protective coating may also contain a flavoring material, and additional components that delay or prevent the access of light, oxygen, and/or water to the matrix. Light barriers such as titanium dioxide, carbon black, edible ink, cocoa, or the like may be employed.

In embodiments of the invention, the coating solution may be applied as a fine mist, atomized by nitrogen and sprayed onto the surface of the pellets in a rotating enrober. Multiple coatings can be applied with intermediate drying in-between coatings. The coating material may constitute from about 1% by weight to about 20% by weight of the final product mass.

Application of the optional protective coating may also be achieved by pan coating the pieces or pellets immediately after extrusion and prior to final drying. Multiple pan coatings can be applied with intermediate drying in-between coating layers. Fluid bed coating, coating with a rotating enrober drum can also be an option for coating the pieces or pellets, though pan coating may prove more efficient and cost effective.

The uncoated pellets, or coated pellets may be dried to their final moisture content in conventional drying equipment such as a static bed tray dryer, a continuous conventional dryer, or a fluid bed (continuous or batch) dryer. Convective drying by air, which may be dehumidified or ambient, nitrogen, or carbon dioxide, may be employed. Exemplary final moisture contents may range from about 2% by weight to about 10% moisture by weight, based upon the weight of the dried pellets, or particulates. The drying temperature may range from ambient to 100° C., or more preferably ambient to about 65° C. The pellets or particulates may be dried to achieve a shelf stable water activity of less than or equal to about 0.7 and a storage stability or shelf life of at least about six months, preferably at least about twelve months, most preferably at least about thirty-six months. In embodiments of the invention the shelf stable water activity may be less than or equal to about 0.9 in a moist product where an optional antimycotic or antimicrobial agent may be employed.

In embodiments of the invention, the encapsulated component such as fish oil or flax oil, or oil from algae, may contain up to about 90% by weight readily oxidizable components, for example up to about 45% by weight, preferably from about 1% by weight to about 40% by weight, more preferably from about 10% by weight to about 30% by weight oil or other readily oxidizable components, such as polyunsaturated fatty acids.

The products of the present invention may possess either a hard, non-brittle, or semi-glassy texture. The products of the present invention may be in the form of discrete particles, pellets, or tablets. They may be spherical in shape, curvilinear or lens-shaped, flat discs, oval shaped, or the like. A spherical shape is preferred. In embodiments of the invention, the diameter of the particles may be about 0.2 mm to about 3 mm, preferably from about 0.4 mm to about 0.9 mm and a length of about 0.2 mm to about 3 mm, preferably from about 0.4 mm to about 0.9 mm, and the length-to-diameter ratio (lid) ratio may be from about 0.5 to about 2, preferably about 1. The particles are generally uniform in size, may be hard or partially glassy, and granular in a substantially compact form that is visually and texturally compatible with the texture of the baked good, and is preferably non-discernable or not readily detectable visually or texturally by the consumer. The products of the invention are non-expanded, generally not leavened, and may exhibit a non-puffed, substantially non-cellular structure. The starch component of the matrices may be substantially ungelatinized or partially gelatinized, and not substantially destructurizedi or dextrinized. Exemplary specific densities of the products of the present invention are between about 800 g/liter and about 1500 g/liter (about 0.8 to about 1.5 g/cm³).

The encapsulated products of the present invention may be incorporated into conventional baked good doughs and baked products using conventional baked good formulas, mixing procedures, and equipment.

Additionally, the method of the present invention comprises encapsulating an oil comprising a polyunsaturated fatty acid for incorporating into a baked good without substantial smearing and dissolution of the encapsulated product during mixing of the encapsulated product in a baked good dough or batter. The method of encapsulation includes forming an oil-in-water emulsion comprising at least one polyunsaturated fatty acid and a film-forming component which preferably is a film-forming protein. The oil-in-water emulsion is admixed with a matrix material, a liquid plasticizer for plasticizing the matrix material, and an acidic antioxidant for preventing oxidation of the at least one polyunsaturated fatty acid. The matrix material comprises a starch component and a protein component with the amount of protein in the matrix material being from about 35% by weight to about 75% by weight, preferably from about 45% by weight to about 65% by weight, based upon the weight of the matrix material. The admixing is conducted so as to obtain a formable mixture where the matrix material contains the acidic antioxidant and encapsulates oil droplets of the oil-in water emulsion. The formable mixture is formed into pieces, and the pieces are dried to obtain dried pieces of encapsulated product, wherein the protein content of the encapsulated product is from about 25% by weight to about 65% by weight, preferably from about 40% by weight to about 60% by weight, based upon the weight of the encapsulated product. In embodiments of the invention, the starch component and the protein component may be preblended to obtain the matrix material, and the matrix material may be admixed with the acidic antioxidant, the emulsion, and the plasticizer to at least substantially plasticize the matrix material, and to substantially uniformly distribute the antioxidant throughout the matrix material.

The method for incorporating an oil comprising a polyunsaturated fatty acid into a baked good comprises admixing the encapsulated product with baked good dough or batter ingredients comprising flour and water to obtain a dough or batter without substantial smearing and dissolution of the encapsulated product in the dough or batter. The doughs or batters may be baked to obtain baked goods such as breads, biscuits, rolls, buns, cakes, muffins, breadsticks, pretzels, pizza, cookies, crackers, and snacks, without substantial smearing and dissolution of the encapsulated product in the baked goods.

The present invention is further illustrated by the following non-limiting examples where all parts, percentages, proportions, and ratios are by weight, and all temperatures are in ° C. unless otherwise indicated:

### Example 1

This Example demonstrates the production of encapsulated products containing polyunsaturated fatty acids (algae oil), and the effect of matrix material protein content, protein content of the encapsulated product, and pellet size on the physical survival of the encapsulated products in bread. The Example also demonstrates the stabilizing effect of an acidic antioxidant (ascorbic acid) on omega-3 oils incorporated in the encapsulated products in bread. The ingredients and their relative amounts which may be used to produce the encapsulated products are shown in Table 1:

TABLE 1
Product formulas of variations bread-1 through bread-19 expressed as
wt % as is after extrusion/anticaking processing:

| Ingredients | | | | | | | | | |
|---|---|---|---|---|---|---|---|---|---|
| (% moisture/% protein) | 1% | 2% | 3% | 4% | 5% | 6% | 7% | 8% | 9% |
| Durum Flour (12/15) | 59.3 | 57.6 | 59.7 | 60.8 | 30.6 | 46.6 | 46.6 | 46.6 | 46.3 |
| Wheat Protein (3/100) | 0.0 | 0.0 | 0.0 | 0.0 | 30.6 | 11.7 | 11.7 | 11.6 | 11.6 |
| Algae Oil (0/0) | 9.7 | 9.1 | 9.4 | 9.8 | 10.1 | 9.4 | 9.4 | 9.7 | 9.7 |
| Ca-Carbonate (0.2/0) | 5.4 | 5.1 | 3.4 | 3.4 | 3.4 | 5.4 | 5.4 | 5.4 | 5.4 |
| Corn Starch (13/0) | 5.4 | 5.1 | 3.4 | 3.4 | 3.4 | 5.4 | 5.4 | 5.4 | 5.4 |
| Ascorbic Acid (0/0) | 0.0 | 0.0 | 0.0 | 0.0 | 0.0 | 0.0 | 0.0 | 0.0 | 0.0 |
| Erythorbic Acid (0/0) | 0.0 | 0.0 | 0.0 | 0.0 | 0.0 | 0.0 | 0.0 | 0.0 | 2.3 |
| Glycerol (0/0) | 1.9 | 0.0 | 0.0 | 1.0 | 0.0 | 0.0 | 0.0 | 1.9 | 0.0 |
| Na-Caseinate (4.9/100) | 0.9 | 0.9 | 0.9 | 0.9 | 1.0 | 0.9 | 0.9 | 0.9 | 0.9 |
| Grindox 204 (0/0) | 0.010 | 0.009 | 0.009 | 0.010 | 0.010 | 0.009 | 0.009 | 0.010 | 0.010 |
| Water (100/0) | 17.4 | 22.3 | 23.1 | 20.6 | 20.9 | 20.8 | 20.8 | 18.5 | 18.6 |
| Total | 100.0 | 100.0 | 100.0 | 100.0 | 100.0 | 100.0 | 100.0 | 100.0 | 100.0 |
| Ingredients | | | | | | | | | |
| (% moisture/% | | | | | | | | | |
| protein) | 10% | 11% | 12% | 13% | 14% | 15% | 16% | 17, 18% | 19% |
| Durum Flour (12/15) | 44.5 | 30.3 | 30.3 | 30.3 | 30.0 | 29.6 | 28.9 | 28.9 | 28.9 |
| Wheat Protein (3/ | 11.1 | 30.3 | 30.3 | 30.3 | 30.0 | 29.6 | 28.9 | 28.9 | 28.9 |
| 100) | | | | | | | | | |
| Algae Oil (0/0) | 9.7 | 10.0 | 10.0 | 10.0 | 10.4 | 10.7 | 10.4 | 10.0 | 10.0 |
| Ca-Carbonate (0.2/0) | 5.4 | 5.4 | 5.4 | 5.4 | 5.4 | 5.4 | 5.4 | 5.6 | 5.6 |
| Corn Starch (13/0) | 5.4 | 5.4 | 5.4 | 5.4 | 5.4 | 5.4 | 5.4 | 5.6 | 5.6 |
| Ascorbic Acid (0/0) | 0.0 | 0.0 | 0.0 | 0.0 | 2.4 | 5.0 | 2.4 | 0.0 | 2.3 |
| Erythorbic Acid (0/0) | 2.3 | 0.0 | 0.0 | 0.0 | 0.0 | 0.0 | 0.0 | 2.3 | 0.0 |
| Glycerol (0/0) | 1.9 | 0.0 | 0.0 | 0.0 | 0.0 | 0.0 | 2.1 | 0.0 | 0.0 |
| Na-Caseinate (4.9/ | 0.9 | 1.0 | 1.0 | 1.0 | 1.0 | 1.0 | 1.0 | 1.0 | 1.0 |
| 100) | | | | | | | | | |
| Grindox 204 (0/0) | 0.010 | 0.010 | 0.010 | 0.010 | 0.010 | 0.011 | 0.010 | 0.010 | 0.010 |
| Water (100/0) | 18.8 | 17.6 | 17.6 | 17.6 | 15.4 | 13.3 | 15.6 | 17.7 | 17.7 |
| Total | 100.0 | 100.0 | 100.0 | 100.0 | 100.0 | 100.0 | 100.0 | 100.0 | 100.0 |

The product formulas of variations for the breads expressed as a weight % as is after extrusion (wet) and weight percent final product (dry) with 6.5% final moisture content are shown in Table 2:

TABLE 2
Product formulas of variations bread-1 through bread-19 expressed as
wt % as is after extrusion (wet) and wt % final product (dry) with 6.5% final
moisture:

| Ingredients | 1 | | | 2 | | | 3 | | |
|---|---|---|---|---|---|---|---|---|---|
| (% moisture/% protein) | % wet | % dry | % prot | % | % dry | % prot | % | % dry | % prot |
| Durum Flour (12/15) | 66.4 | 75.4 | 11.3 | 64.1 | 78.1 | 11.7 | 64.1 | 78.1 | 11.7 |
| Wheat Protein (3/100) | 0.0 | 0.0 | 0.0 | 0.0 | 0.0 | 0.0 | 0.0 | 0.0 | 0.0 |
| Algae Oil (0/0) | 10.9 | 14.0 | — | 10.1 | 14.0 | — | 10.1 | 14.0 | — |
| Ascorbic Acid (0/0) | 0.0 | 0.0 | — | 0.0 | 0.0 | — | 0.0 | 0.0 | — |
| Erythorbic Acid (0/0) | 0.0 | 0.0 | — | 0.0 | 0.0 | — | 0.0 | 0.0 | — |
| Glycerol (0/0) | 2.2 | 2.8 | — | 0.0 | 0.0 | — | 0.0 | 0.0 | — |
| Na-Caseinate (4.9/100) | 1.0 | 1.3 | 1.3 | 1.0 | 1.3 | 1.3 | 1.0 | 1.3 | 1.3 |
| Grindox 204 (0/0) | 0.011 | 0.014 | — | 0.010 | 0.014 | — | 0.010 | 0.014 | — |
| Water (100/0) | 19.5 | 6.5 | — | 24.8 | 6.5 | — | 24.8 | 6.5 | — |
| Total | 100.0 | 100.0 | 12.6 | 100.0 | 100.0 | 13.0 | 100.0 | 100.0 | 13.0 |

| | | | |
|---|---|---|---|
| Ingredients | 4 | 5 | 6 |

| (% moisture/% protein) | % | % dry | % prot | % | % dry | % prot | % | % dry | % prot |
|---|---|---|---|---|---|---|---|---|---|
| Durum Flour (12/15) | 65.3 | 76.8 | 11.5 | 32.8 | 37.3 | 5.6 | 52.2 | 61.4 | 9.2 |
| Wheat Protein (3/100) | 0.0 | 0.0 | 0.0 | 32.8 | 41.1 | 41.1 | 13.1 | 16.9 | 16.9 |
| Algae Oil (0/0) | 10.5 | 14.0 | — | 10.9 | 14.0 | — | 10.5 | 14.0 | — |
| Ascorbic Acid (0/0) | 0.0 | 0.0 | — | 0.0 | 0.0 | — | 0.0 | 0.0 | — |
| Erythorbic Acid (0/0) | 0.0 | 0.0 | — | 0.0 | 0.0 | — | 0.0 | 0.0 | — |
| Glycerol (0/0) | 1.1 | 1.4 | — | 0.0 | 0.0 | — | 0.0 | 0.0 | — |
| Na-Caseinate (4.9/100) | 1.0 | 1.3 | 1.3 | 1.0 | 1.3 | 1.3 | 1.0 | 1.3 | 1.3 |
| Grindox 204 (0/0) | 0.011 | 0.014 | — | 0.011 | 0.014 | — | 0.011 | 0.014 | — |
| Water (100/0) | 22.1 | 6.5 | — | 22.4 | 6.5 | — | 23.3 | 6.5 | — |
| Total | 100.0 | 100.0 | 12.8 | 100.0 | 100.0 | 47.9 | 100.0 | 100.0 | 27.4 |
| Ingredients | 7 | | | 8 | | | 9 | | |
| (% moisture/% protein) | % | % dry | % prot | % | % dry | % prot | % | % dry | % prot |
| Durum Flour (12/15) | 52.2 | 61.4 | 9.2 | 52.2 | 59.2 | 8.9 | 51.8 | 58.8 | 8.8 |
| Wheat Protein (3/100) | 13.1 | 16.9 | 16.9 | 13.0 | 16.3 | 16.3 | 13.0 | 16.2 | 16.2 |
| Algae Oil (0/0) | 10.5 | 14.0 | — | 10.9 | 14.0 | — | 10.9 | 14.0 | — |
| Ascorbic Acid (0/0) | 0.0 | 0.0 | — | 0.0 | 0.0 | — | 0.0 | 0.0 | — |
| Erythorbic Acid (0/0) | 0.0 | 0.0 | — | 0.0 | 0.0 | — | 2.5 | 3.3 | — |
| Glycerol (0/0) | 0.0 | 0.0 | — | 2.2 | 2.8 | — | 0.0 | 0.0 | — |
| Na-Caseinate (4.9/100) | 1.0 | 1.3 | 1.3 | 1.0 | 1.3 | 1.3 | 1.0 | 1.3 | 1.3 |
| Grindox 204 (0/0) | 0.011 | 0.014 | — | 0.011 | 0.014 | — | 0.011 | 0.014 | — |
| Water (0/0) | 23.3 | 6.5 | — | 20.7 | 6.5 | — | 20.8 | 6.5 | — |
| Total | 100.0 | 100.0 | 27.4 | 100.0 | 100.0 | 26.5 | 100.0 | 100.0 | 26.3 |
| Ingredients | 10 | | | 11 | | | 12 | | |
| (% moisture/% protein) | % | % dry | % prot | % | % dry | % prot | % | % dry | % prot |
| Durum Flour (12/15) | 49.9 | 56.6 | 8.5 | 34.0 | 37.3 | 5.6 | 34.0 | 37.3 | 5.6 |
| Wheat Protein (3/100) | 12.5 | 15.6 | 15.6 | 34.0 | 41.1 | 41.1 | 34.0 | 41.1 | 41.1 |
| Algae Oil (0/0) | 10.9 | 14.0 | — | 11.3 | 14.0 | — | 11.3 | 14.0 | — |
| Ascorbic Acid (0/0) | 0.0 | 0.0 | — | 0.0 | 0.0 | — | 0.0 | 0.0 | — |
| Erythorbic Acid (0/0) | 2.5 | 3.3 | — | 0.0 | 0.0 | — | 0.0 | 0.0 | — |
| Glycerol (0/0) | 2.2 | 2.8 | — | 0.0 | 0.0 | — | 0.0 | 0.0 | — |
| Na-Caseinate (4.9/100) | 1.0 | 1.3 | 1.3 | 1.1 | 1.3 | 1.3 | 1.1 | 1.3 | 1.3 |
| Grindox 204 (0/0) | 0.011 | 0.014 | — | 0.011 | 0.014 | — | 0.011 | 0.014 | — |
| Water (100/0) | 21.0 | 6.5 | — | 19.8 | 6.5 | — | 19.8 | 6.5 | — |
| Total | 100.0 | 100.0 | 25.4 | 100.0 | 100.0 | 47.9 | 100.0 | 100.0 | 47.9 |
| Ingredients | 13 | | | 14 | | | 15 | | |
| (% moisture/% protein) | % | % dry | % prot | % | % dry | % prot | % | % dry | % prot |
| Durum Flour (12/15) | 34.0 | 37.3 | 5.6 | 33.6 | 35.7 | 5.4 | 33.2 | 34.1 | 5.1 |
| Wheat Protein (3/100) | 34.0 | 41.1 | 41.1 | 33.6 | 39.4 | 39.4 | 33.2 | 37.6 | 37.6 |
| Algae Oil (0/0) | 11.3 | 14.0 | — | 11.6 | 14.0 | — | 12.0 | 14.0 | — |
| Ascorbic Acid (0/0) | 0.0 | 0.0 | — | 2.7 | 3.3 | — | 5.6 | 6.5 | — |
| Erythorbic Acid (0/0) | 0.0 | 0.0 | — | 0.0 | 0.0 | — | 0.0 | 0.0 | — |
| Glycerol (0/0) | 0.0 | 0.0 | — | 0.0 | 0.0 | — | 0.0 | 0.0 | — |
| Na-Caseinate (4.9/100) | 1.1 | 1.3 | 1.3 | 1.1 | 1.3 | 1.3 | 1.1 | 1.3 | 1.3 |
| Grindox 204 (0/0) | 0.011 | 0.014 | — | 0.012 | 0.014 | — | 0.012 | 0.014 | — |
| Water (100/0) | 19.8 | 6.5 | — | 17.3 | 6.5 | — | 14.9 | 6.5 | — |
| Total | 100.0 | 100.0 | 47.9 | 100.0 | 100.0 | 46.0 | 100.0 | 100.0 | 44.0 |
| Ingredients | 16 | | | 17, 18 | | | 19 | | |
| (% moisture/% protein) | % | % dry | % prot | % | % dry | % prot | % | % dry | % prot |
| Durum Flour (12/15) | 32.4 | 34.4 | 5.2 | 33.6 | 35.7 | 5.4 | 32.5 | 35.7 | 5.4 |
| Wheat Protein (3/100) | 32.4 | 37.9 | 37.9 | 33.6 | 39.4 | 39.4 | 32.5 | 39.4 | 39.4 |
| Algae Oil (0/0) | 11.6 | 14.0 | — | 11.6 | 14.0 | — | 11.3 | 14.0 | — |
| Ascorbic Acid (0/0) | 2.7 | 3.3 | — | 0.0 | 0.0 | — | 2.6 | 3.3 | — |
| Erythorbic Acid (0/0) | 0.0 | 0.0 | — | 2.7 | 3.3 | — | 0.0 | 0.0 | — |
| Glycerol (0/0) | 2.3 | 2.8 | — | 0.0 | 0.0 | — | 0.0 | 0.0 | — |
| Na-Caseinate (4.9/100) | 1.1 | 1.3 | 1.3 | 1.1 | 1.3 | 1.3 | 1.1 | 1.3 | 1.3 |
| Grindox 204 (0/0) | 0.012 | 0.014 | — | 0.012 | 0.014 | — | 0.011 | 0.014 | — |
| Water (100/0) | 17.5 | 6.5 | — | 17.3 | 6.5 | — | 20.0 | 6.5 | — |
| Total | 100.0 | 100.0 | 44.3 | 100.0 | 100.0 | 46.0 | 100.0 | 100.0 | 46.0 |

An emulsion may be prepared in accordance with the present invention by admixing the algae oil, Grindox 204 antioxidant TBHQ, a portion of the water, and sodium caseinate dissolved in 10% by weight of the water in an inline mixer to form a pre- or raw emulsion. The pre-emulsion may then be subjected to high pressure homogenization in a MICROFLUIDICS microfluidizer at about 10,000 psi to obtain a stable emulsion. The durum flour and wheat protein isolate may be preblended in a ribbon blender to obtain a substantially homogeneous matrix material, which may then be added to the first barrel of an extruder. The acidic antioxidant, (ascorbic acid or erythorbic acid) may be added to the first barrel for substantial homogeneous mixing with the matrix material. The stable emulsion may be fed to the second barrel, followed by addition of the remaining water and optional glycerin in the third barrel. The ingredients may be mixed and blended and kneaded in the remaining extruder barrels and extruded at a die temperature of about 122° F. (50° C.) and die pressure of about 500 psi and extruded through a plurality of die apertures and cut into pellets. An anticaking mix of corn starch and calcium carbonate may be applied to the surface of the pellets in the pellet cutting box, and then the pellets may be dried to obtain encapsulated products having a moisture content of about 6.5% by weight. Several of the samples may contain a blue food color dye to ascertain smearing and dissolution of the pellets during production of the bread doughs.

The pellets were incorporated into a conventional bread dough using a conventional bread making machine using a medium crust setting. The bread formulation is shown in Table 3 and bread making procedure is:

TABLE 3
White bread formula, modified for Bread Machine:

| | | Bread | Total |
|---|---|---|---|
| Ingredients | Functionality | Formula | Percent |
| Flour | main ingredient of bread | 403.89 | 51.99 |
| Soy Oil | fat, plasticizer | 11.10 | 1.43 |
| Paniplex-SK SSL | sodium stearoyl lactylate, | 1.85 | 0.24 |
| | emulsifier/dough | | |
| | strengthener | | |
| Vital Wheat Gluten | dough strengthener | 11.10 | 1.43 |
| Monoglycerides | emulsifier/softener | 1.85 | 0.24 |
| Enrichment | e.g. iron | 0.17 | 0.02 |
| Novamyl | fresh keeping enzyme/bread | 0.17 | 0.02 |
| | softener | | |
| Sucrose | sugar, sweetener | 59.20 | 7.62 |
| Salt, filled | flavor | 9.25 | 1.19 |
| Calcium Propionate | preservative | 1.18 | 0.15 |
| Ascorbic Acid | oxidizer/dough strengthener | 0.036 | 0.005 |
| ADA | azodicarbonamide, | 0.009 | 0.001 |
| | oxidizer/dough | | |
| | strengthener | | |
| Datem Powder | emulsifier/dough strengthener | 1.85 | 0.24 |
| Guar Gum | hydrocolloid, water | 0.93 | 0.12 |
| | management agent | | |
| Water | plasticizer | 268.25 | 34.53 |
| Dry Yeast | leavening agent | | |
| Total Weight | | 776.8 | 100.0 |
| dough (wet) | | | |
| Total Weight | | 502.6 | 64.7 |
| flour pre-mix | | | |
| Total Weight of | | 691.4 | 89.0 |
| Baked Loaf | | | |

Procedure: (See Bread Machine manual for additional recommendations)
1. Oil shaft for blade and place blade on shaft.
2. Weigh water into bread pan.
3. Add bread mix.
4. Add yeast and DHA encapsulant and lightly stir into top of mix.
5. Run bread machine at settings of 1.5 lb White Bread, Medium Crust color.
Calculation DHA addition:
Serving Size: 32 mg/50 g

### Total Weight of Baked Loaf: 691.4 g

### Number of Servings per Bread: 13.8

Amount of pellets per Bread: 10.8 g

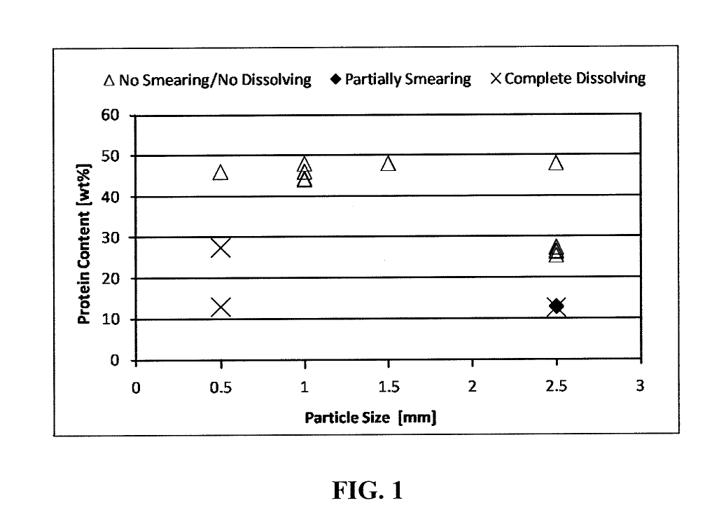

The results and process variables are shown in Table 4 and in FIG. 1. As shown in Table 4 and FIG. 1, as the pellet particle size decreased, higher protein contents were needed to avoid unsatisfactory smearing and complete dissolution of the pellets during dough mixing and baking. For particle sizes of about 2.5 mm in diameter at least about 25% by weight protein content in the pellets was required to avoid dissolution or smearing of the pellets in the dough and baked good whereas protein contents above 40% by weight resulted in no dissolution or smearing for particles having diameters of only 0.5 mm.

Also, sensory tests performed by a panel indicated that fishy taint, malodors and mal-tastes were exhibited by bread samples where the encapsulated products failed the physical survival tests, and by samples which did not contain an acidic antioxidant in the matrix material. The most favorable results were obtained with Bread 19:

TABLE 4
Process variables and results of physical survival

Constants:
Homogenizer: Microfluidizer from Microfluidics
Homogenization: 1 pass at 10,000 psi
Antioxidant: TBHQ, 200 ppm
Encapsulant: DHA-S algae oil from Martek
Oil Content: 13% d.m.
Variables:

| | | WPI in | Glycerin | Acid | | Particle | | Physical Survival | Protein | Extruder Die | Extruder Die |
|---|---|---|---|---|---|---|---|---|---|---|---|
| Sample | | Matrix | Conc | Conc | Acid | Size | Color | in Bread | Content* | Temperature | Pressure |
| Code | DOM | [%] | [%] | [%] | Type | [mm] | Addition | [yes/no] | [wt %] | [F.] | [PSI] |
| Bread-1 | Sep. 16, 2008 | 0 | 3.0 | 0.0 | — | 2.5 | Blue | No | 12.6 | 95 | 185 |
| Bread-2 | Sep. 17, 2008 | 0 | 0.0 | 0.0 | — | 0.5 | Blue | No | 13.0 | 80 | 310 |
| Bread-3 | Sep. 17, 2008 | 0 | 0.0 | 0.0 | — | 2.5 | Blue | Fraction | 13.0 | 80 | 210 |
| Bread-4 | Sep. 17, 2008 | 0 | 1.5 | 0.0 | — | 2.5 | Blue | Fraction | 12.8 | 79 | 190 |
| Bread-5 | Sep. 17, 2008 | 50 | 0.0 | 0.0 | — | 2.5 | Blue | Yes | 47.9 | 95 | 300 |
| Bread-6 | Sep. 17, 2008 | 20 | 0.0 | 0.0 | — | 0.5 | Blue | No | 27.4 | 83 | 365 |
| Bread-7 | Sep. 18, 2008 | 20 | 0.0 | 0.0 | — | 2.5 | Blue | Yes | 27.4 | 83 | 325 |
| Bread-8 | Sep. 18, 2008 | 20 | 3.0 | 0.0 | — | 2.5 | Blue | Yes | 26.5 | 88 | 325 |
| Bread-9 | Sep. 18, 2008 | 20 | 0.0 | 3.5 | EA | 2.5 | Blue | Yes | 26.3 | 92 | 250 |
| Bread-10 | Sep. 18, 2008 | 20 | 3.0 | 3.5 | EA | 2.5 | Blue | Yes | 25.4 | 84 | 245 |
| Bread-11 | Oct. 8, 2008 | 50 | 0.0 | 0.0 | — | 1 | Blue | Yes | 47.9 | 93 | 480 |
| Bread-12 | Oct. 8, 2008 | 50 | 0.0 | 0.0 | — | 1.5 | Blue | Yes | 47.9 | 90 | 500 |
| Bread-13 | Oct. 22, 2008 | 50 | 0.0 | 0.0 | — | 1 | No | Yes | 47.9 | 116 | 345 |
| Bread-14 | Oct. 22, 2008 | 50 | 0.0 | 3.5 | AA | 1 | No | Yes | 46.0 | 110 | 300 |
| Bread-15 | Oct. 22, 2008 | 50 | 0.0 | 7.0 | AA | 1 | No | Yes | 44.0 | 119 | 495 |
| Bread-16 | Oct. 22, 2008 | 50 | 3.0 | 3.5 | AA | 1 | No | Yes | 44.3 | 111 | 445 |
| Bread-17 | Nov. 6, 2008 | 50 | 0.0 | 3.5 | EA | 0.5 | No | Yes | 46.0 | 105 | 480 |
| Bread-18 | Nov. 6, 2008 | 50 | 0.0 | 3.5 | EA | 1 | No | Yes | 46.0 | 119 | 290 |
| Bread-19 | Mar. 18, 2009 | 50 | 0.0 | 3.5 | AA | 0.5 | No | Yes | 46.0 | 108 | 290 |

*Protein content based on dry extrudate excluding anticaking (final moisture: 6.5%)
Legend:
WPI: Wheat Protein Isolate
AA: Ascorbic Acid
EA: Erythorbic Acid

### Example 2

This Example demonstrates the production of encapsulated products containing polyunsaturated fatty acids (algae oil) and the use of the encapsulated products in a commercial white bread application. The Example shows the effect of matrix material protein content, protein content of the encapsulated product, and glycerin content of the encapsulated product on the sensorial and oxidative stability of the encapsulated product, the physical survival of the encapsulated products in commercial style bread, and the sensorial stability of bread fortified with the encapsulated product.

### Production of Encapsulated Products

The ingredients and their relative amounts which may be used to produce the encapsulated products are shown in Table 5:

TABLE 5
Product formulas of variations 1 through 17 expressed as wt % as is after
extrusion/anticaking processing:

| Ingredients | | | | | | | | | |
|---|---|---|---|---|---|---|---|---|---|
| (% moisture/% protein) | 1% | 2% | 3% | 4% | 5% | 6% | 7% | 8% | 9% |
| Durum Flour (12/10) | 56.7 | 53.0 | 49.0 | 41.5 | 38.9 | 35.9 | 27.0 | 26.3 | 25.3 |
| Wheat Protein (3/100) | 0.0 | 0.0 | 0.0 | 13.8 | 13.0 | 12.0 | 27.0 | 26.3 | 25.3 |
| Algae Oil (0/0) | 9.7 | 10.0 | 10.4 | 9.7 | 10.0 | 10.4 | 9.7 | 9.8 | 10.0 |
| Ca-Carbonate (0.2/0) | 6.9 | 7.1 | 7.3 | 6.9 | 7.1 | 7.3 | 6.9 | 6.9 | 7.1 |
| Corn Starch (13/0) | 6.9 | 7.1 | 7.3 | 6.9 | 7.1 | 7.3 | 6.9 | 6.9 | 7.1 |
| Ascorbic Acid (0/0) | 2.3 | 2.3 | 2.4 | 2.3 | 2.3 | 2.4 | 2.3 | 2.3 | 2.3 |
| Citric Acid (0/0) | 1.9 | 2.0 | 2.1 | 1.9 | 2.0 | 2.1 | 1.9 | 2.0 | 2.0 |
| Glycerol (0/0) | 0.0 | 5.0 | 10.4 | 0.0 | 5.0 | 10.4 | 0.0 | 2.0 | 5.0 |
| Na-Caseinate (4.9/100) | 0.9 | 1.0 | 1.0 | 0.9 | 1.0 | 1.0 | 0.9 | 0.9 | 1.0 |
| Grindox 204 (0/0) | 0.010 | 0.010 | 0.010 | 0.010 | 0.010 | 0.010 | 0.010 | 0.010 | 0.010 |
| Water (100/0) | 14.8 | 12.4 | 10.2 | 16.1 | 13.7 | 11.3 | 17.4 | 16.6 | 14.9 |
| Total | 100.0 | 100.0 | 100.0 | 100.0 | 100.0 | 100.0 | 100.0 | 100.0 | 100.0 |

| Ingredients | | | | | | | | |
|---|---|---|---|---|---|---|---|---|
| (% moisture/% protein) | 10% | 11% | 12% | 13% | 14% | 15% | 16% | 17% |
| Durum Flour (12/10) | 23.3 | 13.2 | 12.3 | 11.4 | 56.7 | 55.1 | 44.4 | 37.7 |
| Wheat Protein (3/100) | 23.3 | 39.6 | 37.0 | 34.2 | 0.0 | 0.0 | 7.8 | 12.6 |
| Algae Oil (0/0) | 10.4 | 9.7 | 10.0 | 10.4 | 9.7 | 9.8 | 10.0 | 10.3 |
| Ca-Carbonate (0.2/0) | 7.3 | 6.9 | 7.1 | 7.3 | 6.9 | 6.9 | 7.1 | 7.3 |
| Corn Starch (13/0) | 7.3 | 6.9 | 7.1 | 7.3 | 6.9 | 6.9 | 7.1 | 7.3 |
| Ascorbic Acid (0/0) | 2.4 | 2.3 | 2.3 | 2.4 | 2.3 | 2.3 | 2.3 | 2.4 |
| Citric Acid (0/0) | 2.1 | 1.9 | 2.0 | 2.1 | 1.9 | 2.0 | 2.0 | 2.1 |
| Glycerol (0/0) | 10.4 | 0.0 | 5.0 | 10.4 | 0.0 | 2.0 | 5.0 | 7.5 |
| Na-Caseinate (4.9/100) | 1.0 | 0.9 | 1.0 | 1.0 | 0.9 | 0.9 | 1.0 | 1.0 |
| Grindox 204 (0/0) | 0.010 | 0.010 | 0.010 | 0.010 | 0.010 | 0.010 | 0.010 | 0.010 |
| Water (100/0) | 12.4 | 18.7 | 16.1 | 13.6 | 14.8 | 14.0 | 13.2 | 12.0 |
| Total | 100.0 | 100.0 | 100.0 | 100.0 | 100.0 | 100.0 | 100.0 | 100.0 |

An emulsion may be prepared in accordance with the present invention by admixing the algae oil, Grindox 204 antioxidant TBHQ, a portion of the water, and sodium caseinate dissolved in 10% by weight of the water in an inline mixer to form a pre- or raw emulsion. The pre-emulsion may then be subjected to high pressure homogenization in a MICROFLUIDICS microfluidizer at about 10,000 psi to obtain a stable emulsion. The durum flour and wheat protein isolate may be preblended in a ribbon blender to obtain a substantially homogeneous matrix material, which may then be added to the first barrel of an extruder. The acidic antioxidant, (ascorbic acid and citric acid) may be added to the first barrel for substantial homogeneous mixing with the matrix material. Water and optional glycerin may be fed into the extruder at the end of the first barrel. The stable emulsion may be fed to the second barrel. The ingredients may be mixed and blended and kneaded in the remaining extruder barrels and extruded at a die temperature of about 84° F. (29° C.) to about 105° F. (41° C.) and a die pressure of about 175 psi to about 545 psi and extruded through a plurality of die apertures having a diameter of 0.5 mm, and cut into pellets. An anticaking mix of corn starch and calcium carbonate may be applied to the surface of the pellets in the pellet cutting box, and then the pellets may be dried to obtain encapsulated products having a moisture content of about 6.5% by weight. The samples contain a blue food color dye to ascertain smearing and dissolution of the pellets during production of the bread doughs.

### Production of Bread Containing Encapsulated Product

The pellets were incorporated into a conventional bread dough using conventional commercial scale bread making equipment. The bread formulation is shown in Table 6 and the commercial bread making method is:

TABLE 6
White bread formula, modified for commercial bread baking method:

| Ingredients | Percentage |
|---|---|
| Flour | 46.14 |
| Plasticizer (Water, Oil) | 33.68 |
| Sugar, Sweetener | 9.23 |
| Enrichment (e.g. Iron) | 4.61 |
| Emulsifier/Dough Strengthener | 3.35 |
| Yeast | 1.73 |
| Salt | 1.04 |
| Preservative | 0.23 |
| TOTAL | 100.0 |

For long pan bread the scaling weight is 23.5 oz or 666 grams, formula above is calculated for 7.4 loaves.
For DHA addition the scaling weight is 675 grams, see DHA calculation below.
The declared weight for baked bread is 20 oz. or 567 grams.
The bake loss is between 10-15%.
Dough moisture is 43.2%.
Moisture of baked bread is 33.3%.
Calculation DHA addition:
Serving Size: 32 mg/50 g

### Total Weight of Baked Loaf: 567.0 g

### Number of Servings per Bread: 11.3

Amount of pellets per Bread: 8.9 g
Amount of pellets applied to batch above: 65.5 g

### Commercial Bread Baking Method:

1. Starting with recipe above weigh out all ingredients for placement in commercial mixer.
2. Put all ingredients into 12 quart 3 speed Hobart mixer model # HL 200.
3. Mix at low speed for 3 minutes, then 10 minutes at high speed.
4. Remove dough from mixer. Cover with a plastic sheet and let rest for 5 minutes.
5. Check dough temperature, it should be around 78-90° F.
6. Cut, weigh and roll into dough balls, letting rest for 10 more minutes.
7. Run dough balls through commercial sheeter-molder, ACME, to make it as long as the pan.
8. Place the sheeted dough in a greased pan.
9. Put pan in a pre-heated commercial proofer box (ANNETS, set for 105° F.) for approximately 1½ hours. The bread is ready for baking when the height of the dough is level with the edge of the pan.
10. Place pans with risen bread dough in pre-heated commercial baking oven at 375° F. for 28 minutes.
11. After removing from oven, let cool until inside temperature is below 100° F. before slicing.
12. Slice using commercial bread slicer (2 slices weighing about 50 g), and bag into plastic storage bags for bread.

### Results of Testing Encapsulated Product and Breads Containing Encapsulated Product

The protein and glycerin contents as well as the extrusion moistures which may be used to produce the encapsulated products are shown in Table 7. Table 7 also shows results for Oxipres stability of the encapsulated products, sensory stability for the pellets and the commercial white bread samples, and the physical survival rate of pellets in the white bread samples:

TABLE 7
Process variables for production of DHA encapsulated product and
results for physical, sensorial, and chemical stability

Constants:
Homogenizer: Microfluidizer from Microfluidics
Homogenization: 1 pass at 10,000 psi
Antioxidant: TBHQ, 200 ppm
Acid Concentration in final product: 3.5% d.m. ascorbic acid, 3% d.m. citric acid
Encapsulant: DHA-S algae oil from Martek
Oil Content: 12.5% d.m. (4.4% d.m. DHA)
Die Diameter: 0.5 mm
Extruder Throughput: 300 g/min (18 kg/hr)
Variables:

| | | | | | | | RESPONSES | | | | | | | | |
|---|---|---|---|---|---|---|---|---|---|---|---|---|---|---|---|
| | | | | | | | | | | | | | | Pellet | |
| | | | | | | | | | | | | | | Survival in | |
| EXPERIMENTAL DESIGN | | | | | | | | Pellet Sensory | | | Bread Sensory | | | Bread | |
| | Dry Matrix | | | Protein | Glycerin | | | Fishy/ | | | Fishy/ | | | Pellet count | |
| | Durum | Wheat | Total | in Final | in Final | Extr | | Marine | Painty | | Marine | Painty | | per cross- | |
| Test | Flour | Protein | Protein | Product* | Product | Moist | Oxipres | [15 pt | [15 pt | Fishy + | [15 pt | [15 pt | Fishy + | section | |
| # | [%] | [%] | [%] | [% d.m.] | [% d.m.] | [%] | [hrs] | Scale] | Scale] | Painty | Scale] | Scale] | Painty | Avg | [Y/N] |
| 1 | 100 | 0 | 10.0 | 8.5 | 0.0 | 25 | 10.00 | 6.1 | 0.0 | 6.1 | 0.6 | 0.1 | 0.7 | 1.2 | YES |
| 2 | 100 | 0 | 10.0 | 7.9 | 7.5 | 22 | 11.70 | 2.8 | 0.0 | 2.8 | 0.3 | 0.2 | 0.5 | 0.0 | NO |
| 3 | 100 | 0 | 10.0 | 7.2 | 15.0 | 19 | 11.80 | 2.6 | 0.0 | 2.6 | 0.4 | 0.3 | 0.7 | 0.0 | NO |
| 4 | 75 | 25 | 32.5 | 24.8 | 0.0 | 25 | 8.90 | 3.3 | 0.0 | 3.3 | 0.3 | 0.3 | 0.6 | 3.0 | YES |
| 5 | 75 | 25 | 32.5 | 22.5 | 7.5 | 22 | 11.00 | 3.1 | 0.0 | 3.1 | 0.4 | 0.4 | 0.8 | 0.8 | YES |
| 6 | 75 | 25 | 32.5 | 20.3 | 15.0 | 19 | 12.00 | 2.3 | 0.0 | 2.3 | 0.1 | 0.2 | 0.3 | 0.0 | NO |
| 7 | 50 | 50 | 55.0 | 41.0 | 0.0 | 25 | 9.18 | 3.1 | 0.3 | 3.4 | 0.0 | 0.2 | 0.2 | 2.4 | YES |
| 8 | 50 | 50 | 55.0 | 39.5 | 3.0 | 24 | 11.16 | 2.2 | 0.0 | 2.2 | 0.1 | 0.2 | 0.3 | 0.2 | YES |
| 9 | 50 | 50 | 55.0 | 37.2 | 7.5 | 22 | 10.98 | 2.0 | 0.0 | 2.0 | 0.1 | 0.1 | 0.2 | 0.2 | YES |
| 10 | 50 | 50 | 55.0 | 33.4 | 15.0 | 19 | 13.38 | 1.9 | 0.0 | 1.9 | 0.1 | 0.1 | 0.2 | 0.0 | NO |
| 11 | 25 | 75 | 77.5 | 57.2 | 0.0 | 25 | 8.70 | 3.3 | 0.7 | 4.0 | 0.1 | 0.1 | 0.2 | 3.4 | YES |
| 12 | 25 | 75 | 77.5 | 51.8 | 7.5 | 22 | 11.28 | 1.6 | 0.0 | 1.6 | 0.1 | 0.0 | 0.1 | 0.4 | YES |
| 13 | 25 | 75 | 77.5 | 46.5 | 15.0 | 19 | 13.95 | 2.5 | 0.0 | 2.5 | 0.1 | 0.1 | 0.2 | 0.2 | YES |
| 14 | 100 | 0 | 10.0 | 8.6 | 0.0 | 25 | 6.00 | 1.9 | 3.3 | 5.2 | 0.4 | 0.3 | 0.7 | 1.0 | YES |
| 15 | 100 | 0 | 10.0 | 8.3 | 3.0 | 24 | 7.67 | 3.6 | 0.2 | 3.8 | 0.2 | 0.2 | 0.4 | 0.0 | NO |
| 16 | 85 | 15 | 23.5 | 16.7 | 7.5 | 22 | 10.54 | 3.3 | 0.0 | 3.3 | 0.2 | 0.3 | 0.5 | 0.0 | NO |
| 17 | 75 | 25 | 32.5 | 21.5 | 11.0 | 20 | 11.32 | 3.1 | 0.0 | 3.1 | 0.2 | 0.3 | 0.5 | 0.0 | NO |

*Protein content based on dry extrudate excluding anticaking (final moisture 6.5%)

Table 8 and Table 9 show statistical results from the full factorial design as indicated in Table 7. Results in Table 8 and Table 9 were calculated with the design of experiments software, Design Expert from Stat-Ease, Inc. For analysis of variance calculation a user defined response surface design was applied where one can choose the design points to use. For statistical analysis of the response parameters a quadric model was chosen.

TABLE 8
Analysis of variance (ANOVA) results for Response Surface Quadratic
Model

| | | | Chem Stab | Sensorial Stab | | Phys Stab |
|---|---|---|---|---|---|---|
| | | | Oxipres | Pellet | Bread | Pellet |
| Statistical Measures | | | Stability | Fishy + Painty | Fishy + Painty | Survival |
| p- | Model | | 0.0028 | 0.0020 | 0.0222 | 0.0010 |
| value | Linear | A-Glycerin | 0.0002 | 0.0030 | 0.6593 | 0.0002 |
| Prob > | | B-Protein | 0.0933 | 0.0189 | 0.0011 | 0.0809 |
| F* | Interactive | AB | 0.6939 | 0.2598 | 0.9604 | 0.0897 |
| | Quadratic | A\hat{ }2 | 0.5813 | 0.0630 | 0.8451 | 0.0075 |
| | | B\hat{ }2 | 0.6207 | 0.2319 | 0.8459 | 0.6612 |

| | | | | |
|---|---|---|---|---|
| Std. Dev. | 1.150 | 0.650 | 0.160 | 0.580 |
| Mean | 10.560 | 3.130 | 0.420 | 0.750 |
| R-Squared** | 0.772 | 0.787 | 0.656 | 0.813 |
| Adeq Precision*** | 8.089 | 8.084 | 5.625 | 9.646 |

*alues of “Prob > F” less than 0.0500 indicate model terms are significant. Values greater than 0.1000 indicate the model terms are not significant. If there are many insignificant model terms (not counting those required to support hierarchy), model reduction may improve the model.
**“R-Squared”, the coefficient of determination, measures the variability in a data set that is accounted for by the statistical model. It provides a measure of how well future outcomes are likely to be predicted by the model. An R-Squared of 1.0 (100%) indicates a perfect fit between the outcome and the values being used for prediction.
***“Adeq Precision” measures the signal to noise ratio. A ratio greater than 4 is desirable indicating that the applied model can be used to navigate the design space.

TABLE 9
Final Equation in Terms of Coded Factors

| | | Chem Stab | Sensorial Stab | | Phys Stab |
|---|---|---|---|---|---|
| Factors of Regression | | Oxipres | Pellet | Bread | Pellet |
| Equation | | Stability | Fishy + Painty | Fishy + Painty | Survival |
| Model | Intercept | 11.26 | 2.24 | 0.38 | 0.22 |
| Linear | A-Glycerin | 2.03 | −0.81 | −0.02 | −1.06 |
| | B-Protein | 0.73 | −0.62 | −0.24 | 0.39 |
| Interactive | AB | 0.20 | 0.34 | 0.00 | −0.47 |
| Quadratic | A\hat{ }2 | −0.35 | 0.73 | −0.02 | 1.04 |
| | B\hat{ }2 | −0.34 | 0.48 | 0.12 | −0.15 |

Note:
Highlighted in bold are the significant coefficients of the regression equations.

Synergistic relationships were shown for the impact of protein in bread pellets on chemical, sensorial and physical stability. Increase of protein in pellets significantly lowers combined fishy/painty aroma in pellets, lowers combined fishy/painty flavor in bread and results indicate an improvement in Oxipres stability and pellet survival. Increase of glycerin significantly increases Oxipres stability and lowers the combined fishy/painty aroma in pellets prior to incorporation into bread, but decreases pellet survival in bread. However, the results indicate that high glycerin levels do not have a negative effect on the bread sensory during a shelf life of 6 months at refrigerated temperature for the pellets and 14 days room temperature for the bread at 32 mg DHA concentration per serving.

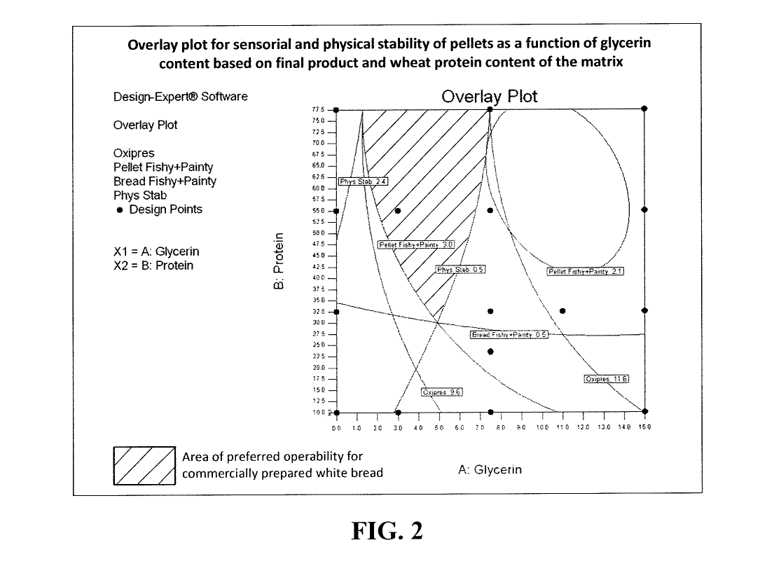

FIG. 2 shows an overlay plot of sensorial and physical stability for bread pellets as a function of glycerin and wheat protein content. To create the plot, minimum limits for physical stability and maximum limits for sensorial stability are set, and an overlay graph is then created highlighting an area of preferred operability. For “Pellet Fishy+Painty,” a limit of ≦3 was chosen since a combined fishy/painty score implies that each individual score never exceeds 3 which is the threshold for detection. For “Physical Stability,” a limit of ≧0.5 was chosen. An average pellet count of 0.5 indicates that at least one pellet survived and at least one physical intact pellet can be found on every second cross-section of the bread or every slice of the bread. As shown in FIG. 2, pellets made under the preferred conditions will have an Oxipres stability of between about 9.6 and about 11.6, and white breads made with the pellet will have a sensory for “Combined Fishy and Painty” flavor score of between 0 and 0.5. FIG. 2 shows the preferred operating window for glycerin and protein in which pellets will not smell fishy and painty after a 6 month storage at refrigerated temperature (flushed, sealed) and also will physically survive in a commercial white bread application without substantial smearing or dissolution. As shown in FIG. 2, the following usage ranges for glycerin and protein define the preferred operating window for the investigated design space:

Glycerin: 1.0%-7.5% by weight, based upon the weight of the encapsulated or final product; and
Protein: 30.0%-77.5% by weight, based upon the weight of matrix.

What is claimed is:

1. An encapsulated product for baked goods which can be incorporated into a baked good dough or batter without substantial smearing or dissolution of the encapsulated product in the dough or batter, said encapsulated product comprising:
a) oil droplets comprising at least one polyunsaturated fatty acid,
b) a film-forming component comprising a protein, said film-forming component coating said oil droplets,
c) a matrix material encapsulating the film-coated oil droplets, said matrix material comprising a starch component and a protein component,
d) a liquid plasticizer which plasticizes said matrix material, and
e) an acidic antioxidant dispersed throughout the plasticized matrix material,
wherein the protein content of the encapsulated product is from about 25% by weight to about 65% by weight, based upon the weight of the encapsulated product, and the amount of protein in said matrix material is from about 35% by weight to about 75% by weight, based upon the weight of said matrix material.

2. An encapsulated product as claimed in claim 1 wherein the protein content of the encapsulated product is from about 40% by weight to about 60% by weight, based upon the weight of the encapsulated product.

3. An encapsulated product as claimed in claim 1 wherein the amount of protein in said matrix material is from about 45% by weight to about 65% by weight, based upon the weight of said matrix material.

4. An encapsulated product as claimed in claim 2 wherein the amount of protein in said matrix material is from about 45% by weight to about 65% by weight, based upon the weight of said matrix material.

5. An encapsulated product as claimed in claim 1 wherein said starch component comprises at least one member selected from the group consisting of high gluten content flours, durum wheat or semolina, pregelatinized or modified starch, corn flour, wheat flour, rice flour, barley flour, oat flour, and rye flour.

6. An encapsulated product as claimed in claim 1 wherein said protein component comprises at least one member selected from the group consisting of vegetable proteins, dairy proteins, animal proteins, and protein concentrates.

7. An encapsulated product as claimed in claim 1 wherein said protein component comprises at least one member selected from the group consisting of wheat protein isolates, vital wheat gluten, gelatin, casein, caseinates, soy protein isolates, and whey protein isolates.

8. An encapsulated product as claimed in claim 5 wherein said protein component comprises at least one member selected from the group consisting of wheat protein isolates, vital wheat gluten, gelatin, casein, caseinates, soy protein isolates, and whey protein isolates.

9. An encapsulated product as claimed in claim 1 wherein said matrix material comprises durum flour and wheat protein isolate.

10. An encapsulated product as claimed in claim 1 wherein said encapsulated product is in the form of discrete particles or pellets having a diameter of from about 0.2 mm to about 3.0 mm.

11. An encapsulated product as claimed in claim 1 wherein said plasticizer comprises at least one liquid polyol for providing mobility to said acidic antioxidant in the plasticized matrix material, the amount of said at least one liquid polyol being less than about 5% by weight, based upon the weight of the encapsulated product.

12. An encapsulated product as claimed in claim 11 wherein said at least one polyol comprises at least one member selected from the group consisting of glycerol, propylene glycol, and sorbitol, and said film forming component comprises at least one caseinate.

13. An encapsulated product as claimed in claim 1 wherein said oil droplets comprise at least one member selected from the group consisting of fish oil, algae oil, flax seed oil, and plant oils from plants genetically modified to include a polyunsaturated fatty acid.

14. An encapsulated product as claimed in claim 1 wherein said acidic antioxidant comprises at least one member selected from the group consisting of citric acid, ascorbic acid, erythorbic acid and salts thereof.

15. An encapsulated product as claimed in claim 14 wherein the amount of said acidic antioxidant is from about 0.5% by weight to about 10% by weight, based upon the weight of the encapsulated product.

16. An encapsulated product as claimed in claim 15, wherein the amount of oil is from about 5% by weight to about 20% by weight, based upon the weight of the encapsulated product.

17. An encapsulated product as claimed in claim 1 having a storage or shelf stability of at least about 6 months under nitrogen flushed room temperature conditions.

18. An encapsulated product as claimed in claim 1 having a storage or shelf stability of at least about 12 months under nitrogen flushed room temperature conditions.

19. A baked good dough or batter comprising an encapsulated product as claimed in claim 1.

20. A bread dough comprising an encapsulated product as claimed in claim 1.

21. A baked good comprising an encapsulated product as claimed in claim 1.

22. A baked good as claimed in claim 19 which is selected from the group consisting of breads, biscuits, rolls, buns, cakes, muffins, breadsticks, pretzels, pizza, cookies, crackers, and snacks.

23. A baked good comprising an encapsulated product as claimed in claim 17 and a concentration of omega-3 fatty acids of at least about 10 mg per serving, wherein the baked good has a shelf stability of at least 14 days after baking.

24. A baked good comprising an encapsulated product as claimed in claim 17 and a concentration of omega-3 fatty acids of at least about 10 mg per serving, wherein the baked good has a shelf stability of at least about six months after baking.

25. A baked good mix comprising an encapsulated product as claimed in claim 1.

26. A package comprising a high moisture and/or high oxygen barrier material in the form of a bag or pouch containing a nitrogen flushed encapsulated product of claim 1.

27. A baked good product kit comprising a package as claimed in claim 26 and a package containing a premix of baked good ingredients comprising flour.

28. A method for encapsulating an oil comprising a polyunsaturated fatty acid for incorporating into a baked good without substantial smearing and dissolution of the encapsulated product during mixing of the encapsulated product in a baked good dough or batter comprising:
a) forming an oil-in-water emulsion comprising at least one polyunsaturated fatty acid and a film-forming component comprising a protein,
b) admixing said oil-in-water emulsion with a matrix material, a liquid plasticizer for plasticizing said matrix material, and an acidic antioxidant for preventing oxidation of said at least one polyunsaturated fatty acid, said matrix material comprising a starch component and a protein component with the amount of protein in said matrix material being from about 35% by weight to about 75% by weight, based upon the weight of said matrix material, said admixing being such so as to obtain a formable mixture wherein said matrix material contains said acidic antioxidant and encapsulates oil droplets of said oil-in water emulsion,
c) forming said formable mixture into pieces, and
d) drying said pieces to obtain dried pieces of encapsulated product, wherein the protein content of the encapsulated product is from about 25% by weight to about 65% by weight, based upon the weight of the encapsulated product.

29. A method according to claim 28 wherein said starch component and said protein component are preblended to obtain said matrix material, and the matrix material is admixed with said acidic antioxidant, said emulsion, and said plasticizer to at least substantially plasticize said matrix material and to substantially uniformly distribute said antioxidant throughout said matrix material.

30. A method according to claim 29 wherein in said pieces, said oil-in-water emulsion comprises oil droplets comprising at least one polyunsaturated fatty acid, at least substantially all of the oil droplets have a diameter of less than about 2 microns, said film forming component surrounds said oil droplets, and said matrix material and said acid antioxidant surround the film-coated oil droplets.

31. A method as claimed in claim 30 wherein said oil-in-water emulsion is homogenized in a homogenizer to obtain oil droplets wherein at least substantially all of the oil droplets have a diameter of less than about 2 microns, and wherein said emulsion, said antioxidant, said matrix material, and said plasticizer are admixed in an extruder.

32. A method as claimed in claim 28 wherein the protein content of the encapsulated product is from about 40% by weight to about 60% by weight, based upon the weight of the encapsulated product.

33. A method as claimed in claim 28 wherein the amount of protein in said matrix material is from about 45% by weight to about 65% by weight, based upon the weight of said matrix material.

34. A method as claimed in claim 32 wherein the amount of protein in said matrix material is from about 45% by weight to about 65% by weight, based upon the weight of said matrix material.

35. A method as claimed in claim 28 wherein said starch component comprises at least one member selected from the group consisting of high gluten content flours, durum wheat or semolina, pregelatinized or modified starch, corn flour, wheat flour, rice flour, barley flour, oat flour, and rye flour, and wherein said protein component comprises at least one member selected from the group consisting of vegetable proteins, dairy proteins, animal proteins, and protein concentrates.

36. A method as claimed in claim 35 wherein said protein component comprises at least one member selected from the group consisting of wheat protein isolates, vital wheat gluten, gelatin, casein, caseinates, soy protein isolates, and whey protein isolates.

37. A method as claimed in claim 28 wherein said matrix material comprises durum flour and wheat protein isolate, and wherein said encapsulated product is in the form of discrete particles or pellets having a diameter of from about 0.2 mm to about 3.0 mM.

38. A method as claimed in claim 28 wherein said oil droplets comprise at least one member selected from the group consisting of fish oil, algae oil, flax seed oil, and plant oils from plants genetically modified to include a polyunsaturated fatty acid, said acidic antioxidant comprises at least one member selected from the group consisting of citric acid, ascorbic acid, erythorbic acid and salts thereof, the amount of said acidic antioxidant is from about 0.5% by weight to about 10% by weight, based upon the weight of the encapsulated product, and the amount of oil is from about 5% by weight to about 20% by weight, based upon the weight of the encapsulated product.

39. A method for incorporating an oil comprising a polyunsaturated fatty acid into a baked good comprising admixing an encapsulated product as claimed in claim 1 with baked good dough ingredients comprising flour and water to obtain a dough without substantial smearing and dissolution of the encapsulated product in the dough and baking the dough.

40. A method as claimed in claim 39 wherein said baked good is selected from the group consisting of breads, biscuits, rolls, buns, cakes, muffins, breadsticks, pretzels, pizza, cookies, crackers, and snacks.

41. A method as claimed in claim 39 wherein said baked good is bread, the concentration of omega-3 fatty acids in the bread is at least about 16 mg per 50 g serving size, and the bread exhibits shelf stability of at least 14 days after baking.

42. A method as claimed in claim 39 wherein said baked good is a muffin, the concentration of omega-3 fatty acids in the muffin is at least about 16 mg per serving, and the muffin exhibits shelf stability of at least 14 days after baking.

43. A method as claimed in claim 39 wherein said baked good is a cookie, the concentration of omega-3 fatty acids in the cookie is at least about 16 mg per serving, and the cookie exhibits shelf stability of at least about 6 months after baking.

44. A method as claimed in claim 39 wherein said matrix material comprises durum flour and wheat protein isolate, and wherein said encapsulated product is in the form of discrete particles or pellets having a diameter of from about 0.2 mm to about 3.0 mM.

45. An encapsulated product for baked goods which can be incorporated into a baked good dough or batter without substantial smearing or dissolution of the encapsulated product in the dough or batter, said encapsulated product comprising:
a) oil droplets comprising at least one polyunsaturated fatty acid,
b) a film-forming component comprising a protein, said film-forming component coating said oil droplets,
c) a matrix material encapsulating the film-coated oil droplets, said matrix material comprising a starch component and a protein component,
d) a liquid plasticizer which plasticizes said matrix material, and
e) an acidic antioxidant dispersed throughout the plasticized matrix material,
wherein the protein content of the encapsulated product is from about 15% by weight to about 65% by weight, based upon the weight of the encapsulated product, and the amount of protein in said matrix material is from about 25% by weight to about 77.5% by weight, based upon the weight of said matrix material.

46. An encapsulated product as claimed in claim 45 wherein the protein content of the encapsulated product is from about 20% by weight to about 55% by weight, based upon the weight of the encapsulated product.

47. An encapsulated product as claimed in claim 45 wherein the amount of protein in said matrix material is from about 30% by weight to about 65% by weight, based upon the weight of said matrix material.

48. An encapsulated product as claimed in claim 46 wherein the amount of protein in said matrix material is from about 30% by weight to about 65% by weight, based upon the weight of said matrix material.

49. An encapsulated product as claimed in claim 45 wherein said plasticizer comprises at least one liquid polyol for providing mobility to said acidic antioxidant in the plasticized matrix material, the amount of said at least one liquid polyol being less than or equal to about 20% by weight, based upon the weight of the encapsulated product.

50. An encapsulated product as claimed in claim 49 wherein the amount of said at least one liquid polyol is from about 1% by weight to about 7.5% by weight, based upon the weight of the encapsulated product.

51. An encapsulated product as claimed in claim 45 wherein the amount of protein in the matrix material is from about 25% by weight to about 35% by weight, based upon the weight of the matrix material, and the protein content of the encapsulated product is from about 15% by weight to about 25% by weight, based upon the weight of the encapsulated or final product.

52. An encapsulated product as claimed in claim 49 wherein the amount of said at least one liquid polyol is from about 5% by weight to about 20% by weight, based upon the weight of the encapsulated product.

53. A method for encapsulating an oil comprising a polyunsaturated fatty acid for incorporating into a baked good without substantial smearing and dissolution of the encapsulated product during mixing of the encapsulated product in a baked good dough or batter comprising:
a) fowling an oil-in-water emulsion comprising at least one polyunsaturated fatty acid and a film-forming component comprising a protein,
b) admixing said oil-in-water emulsion with a matrix material, a liquid plasticizer for plasticizing said matrix material, and an acidic antioxidant for preventing oxidation of said at least one polyunsaturated fatty acid, said matrix material comprising a starch component and a protein component with the amount of protein in said matrix material being from about 25% by weight to about 77.5% by weight, based upon the weight of said matrix material, said admixing being such so as to obtain a formable mixture wherein said matrix material contains said acidic antioxidant and encapsulates oil droplets of said oil-in water emulsion,
c) forming said formable mixture into pieces, and
d) drying said pieces to obtain dried pieces of encapsulated product, wherein the protein content of the encapsulated product is from about 15% by weight to about 65% by weight, based upon the weight of the encapsulated product.

54. A method as claimed in claim 53 wherein the protein content of the encapsulated product is from about 20% by weight to about 55% by weight, based upon the weight of the encapsulated product.

55. A method as claimed in claim 53 wherein the amount of protein in said matrix material is from about 30% by weight to about 65% by weight, based upon the weight of said matrix material.

56. A method as claimed in claim 54 wherein the amount of protein in said matrix material is from about 30% by weight to about 65% by weight, based upon the weight of said matrix material.

57. A method as claimed in claim 53 wherein said plasticizer comprises at least one liquid polyol for providing mobility to said acidic antioxidant in the plasticized matrix material, the amount of said at least one liquid polyol being less than or equal to about 20% by weight, based upon the weight of the encapsulated product.

58. A method as claimed in claim 57 wherein the amount of said at least one liquid polyol is from about 1% by weight to about 7.5% by weight, based upon the weight of the encapsulated product.

59. A method as claimed in claim 53 wherein the amount of protein in the matrix material is from about 25% by weight to about 35% by weight, based upon the weight of the matrix material, and the protein content of the encapsulated product is from about 15% by weight to about 25% by weight, based upon the weight of the encapsulated or final product.

60. A method as claimed in claim 57 wherein the amount of said at least one liquid polyol is from about 5% by weight to about 20% by weight, based upon the weight of the encapsulated product.
